(19) United States
(12) Patent Application Publication
(10) Pub. No.: US 2025/0201247 A1
(43) Pub. Date: Jun. 19, 2025

(54) Method and System to Personalize User Experience in a Vehicle

(71) Applicant: Mercedes-Benz Group AG, Stuttgart (DE)

(72) Inventors: Sachin Gupta, Santa Clara, CA (US); John Nguyen, San Jose, CA (US); Nikesh Shanegere Raj, Milpitas, CA (US); Albert Zarate, San Jose, CA (US)

(21) Appl. No.: 18/988,107

(22) Filed: Dec. 19, 2024

Related U.S. Application Data
(60) Provisional application No. 63/612,074, filed on Dec. 19, 2023.

(51) Int. Cl. G10L 15/22; B60H 1/00; B60R 16/023; G01C 21/36; G10L 15/18

(52) U.S. Cl. CPC G10L 15/22; B60H 1/00757; B60R 16/0231; G01C 21/3608; G10L 15/1815; G10L 2015/223

(57) ABSTRACT

Methods, computing systems, and technology for personalizing a user experience in a vehicle. For example, a computing system may be configured to receive a user prompt from a user associated with a vehicle, the user prompt indicative of a statement or a question. The computing system may be configured to access sensor data associated with a surrounding environment of the vehicle. The computing system may be configured to generate, using a context engine, a modified user prompt based on the user prompt and the sensor data, wherein the modified user prompt supplements the user prompt with the context data, the context data providing one or more conditions associated with the user prompt. The computing system may be configured to generate, based on the modified user prompt, a user response, wherein the user response implements an action corresponding to the statement or the question.

### CROSS-REFERENCE TO RELATED APPLICATIONS

The present application claims the benefit of and the priority to U.S. Provisional Application No. 63/612,074, filed Dec. 19, 2023. U.S. Provisional Application No. 63/612,074 is hereby incorporated by reference in its entirety.

### FIELD

The present disclosure relates to a method, system, and computer program product for vehicle computing customization.

### BACKGROUND

Voice assistant programs extend the functionality of vehicles allowing drivers and passengers to make hands-free calls, play music on demand, request directions or destination suggestions, etc. For instance, voice assistants may autonomously complete tasks increasing the capacity and productivity of users.

### SUMMARY

Aspects and advantages of implementations of the present disclosure will be set forth in part in the following description, or may be learned from the description, or may be learned through practice of the implementations.

One example aspect of the present disclosure is directed to a computing system of a vehicle. The computing system includes a control circuit configured to receive a user prompt from a user associated with a vehicle, the user prompt indicative of a statement or a question. The control circuit is configured to access sensor data associated with a surrounding environment of the vehicle, the sensor data including at least of (i) an image of the user, (ii) weather data, (iii) a location of the vehicle, or (iv) a timestamp captured by one or more vehicle sensors. The control circuit is configured to generate, using a context engine configured to determine context data associated with at least one of the user or the vehicle, a modified user prompt based on the user prompt and the sensor data, wherein the modified user prompt supplements the user prompt with the context data, the context data providing one or more conditions associated with the user prompt. The control circuit is configured to generate, based on the modified user prompt, a user response, wherein the user response implements an action corresponding to the statement or the question.

In an embodiment, the context engine is configured to analyze the user prompt from the user. In an embodiment, the context engine is configured to, based on the analysis of the user prompt, access user preference data associated with the user, the user preference data associated with the one or more conditions. In an embodiment, the context engine is configured to generate, based on the user prompt and the user preference data, the context data, wherein the context data is indicative of one or more user preferences associated with the user prompt.

In an embodiment, the context engine is configured to concatenate the context data with one or more supplemental topics, the one or more supplemental topics including additional information associated with the user preference data. In an embodiment, the context engine is configured to input the user prompt and the one or more supplemental topics into a machine-learned model, wherein the machine-learned model is configured to generate the user response.

In an embodiment, the context engine is configured to determine, based on the user prompt, the sensor data, and the user preference data, sentiment data associated with the user. In an embodiment, the context engine is configured to generate based on the sentiment data, the modified user prompt.

In an embodiment, the sentiment data includes at least one of (i) a mood, (ii) a feeling, or (iii) a tone of the user.

In an embodiment, the control circuit is configured to generate voice analysis data for the user prompt, wherein the voice analysis data is indicative of a sentiment of the user.

In an embodiment, the one or more conditions associated with the user prompt include the sentiment of the user.

In an embodiment, the user prompt is received from a user computing device.

In an embodiment, the user prompt is received from a vehicle interface located within the vehicle and physically coupled to the vehicle.

In an embodiment, the action includes at least one of: (i) emitting an audio response; (ii) updating a user interface within the vehicle; (iii) adjusting a temperature setting within the vehicle; (iv) providing an entertainment suggestion; (v) providing a destination suggestion; or (vi) adjusting a comfort setting with the vehicle.

In an embodiment, the action is indicative of at least one of: (i) a predicted action of the user or (ii) a predicted action of the vehicle.

In an embodiment, the control circuit is configured to access the sensor data. In an embodiment, the control circuit is configured to, based on the sensor data, generate an automated user prompt, wherein the automated user prompt is associated with a predicted user prompt from the user.

In an embodiment, the control circuit is configured to implement the action in response to the automated user prompt.

In an embodiment, the one or more conditions associated with the user prompt includes at least one of (i) a cabin temperature, (ii) a comfort setting, or (iii) a navigation preset.

One example aspect of the present disclosure is directed to a computer-implemented method. The computer-implemented method includes receiving a user prompt from a user associated with a vehicle, the user prompt indicative of a statement or a question. The computer-implemented method includes accessing sensor data associated with a surrounding environment of the vehicle, the sensor data comprising at least of (i) an image of the user, (ii) weather data, (iii) a location of the vehicle, or (iv) a timestamp captured by one or more vehicle sensors. The computer-implemented method includes generating, using a context engine configured to determine context data associated with at least one of the user or the vehicle, a modified user prompt based on the user prompt and the sensor data, wherein the modified user prompt supplements the user prompt with the context data, the context data providing one or more conditions associated with the user prompt. The computer-implemented method includes generating, based on the modified user prompt, a user response, wherein the user response implements an action corresponding to the statement or the question.

In an embodiment, the method includes analyzing, using the context engine, the user prompt from the user. In an embodiment, the method includes based on the analysis of the user prompt, accessing user preference data associated with the user, the user preference data associated with the one or more conditions. In an embodiment, the method includes generating, using the context engine, based on the user prompt and the user preference data, the context data, wherein the context data is indicative of one or more user preferences associated with the user prompt.

In an embodiment, the method includes concatenating, using the context engine, the context data with one or more supplemental topics, the one or more supplemental topics including additional information associated with the user preference data. In an embodiment, the method includes inputting, by the context engine, the user prompt and the one or more supplemental topics into a machine-learned model, wherein the machine-learned model is configured to generate the user response.

In an embodiment, the method includes determining, using the context engine, based on the user prompt, the sensor data, and the user preference data, sentiment data associated with the user. In an embodiment, the method includes generating, using the context engine, based on the sentiment data, the modified user prompt

In an embodiment, the sentiment data includes at least one of (i) a mood, (ii) a feeling, or (iii) a tone of the user.

In an embodiment, the method includes generating voice analysis data for the user prompt, wherein the voice analysis data is indicative of a sentiment of the user

One example aspect of the present disclosure is directed to a computing system of a vehicle. The computing system includes a control circuit configured to obtain first transformed vehicle operations data associated with a user and a first vehicle, the first transformed vehicle operations data including a first masked input and a first masked output, the first transformed vehicle operations data associated with a first masking key. The control circuit is configured to obtain second transformed vehicle operations data associated with a user and a second vehicle, the second transformed vehicle operations data including a second masked input and a second masked output, the first transformed vehicle operations data associated with a second masking key. The control circuit is configured to determining a compatibility between the first masking key and the second masking key. The control circuit is configured to based on the determined compatibility, generating a masked training dataset including the first transformed vehicle operations data and the second transformed vehicle operations data. The control circuit is configured to train a machine-learned model using the masked training dataset to generate masked outputs based on masked inputs. The control circuit is configured to transmit the trained machine-learned model to at least one of the first vehicle or the second vehicle.

One example aspect of the present disclosure is directed to one or more non-transitory computer-readable media that store instructions that are executable by a control circuit to: receive a user prompt from a user associated with a vehicle, the user prompt indicative of a statement or a question; access sensor data associated with a surrounding environment of the vehicle, the sensor data including at least of (i) an image of the user, (ii) weather data, (iii) a location of the vehicle, or (iv) a timestamp captured by one or more vehicle sensors; generate, using a context engine configured to determine context data associated with at least one of the user or the vehicle, a modified user prompt based on the user prompt and the sensor data, wherein the modified user prompt supplements the user prompt with the context data, the context data providing one or more conditions associated with the user prompt; and generate, based on the modified user prompt, a user response, wherein the user response implements an action corresponding to the statement or the question.

Other example aspects of the present disclosure are directed to other systems, methods, vehicles, apparatuses, tangible non-transitory computer-readable media, and devices for the technology described herein.

These and other features, aspects, and advantages of various implementations will become better understood with reference to the following description and appended claims. The accompanying drawings, which are incorporated in and constitute a part of this specification, illustrate implementations of the present disclosure and, together with the description, serve to explain the related principles.

Other example aspects of the present disclosure are directed to other systems, methods, vehicles, apparatuses, tangible non-transitory computer-readable media, and devices for the technology described herein.

These and other features, aspects, and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 illustrates an example computing ecosystem according to an embodiment hereof.

FIGS. 2A-D illustrate diagrams of an example computing architecture for an onboard computing system of a vehicle according to an embodiment hereof.

FIG. 3 illustrates an example vehicle interior with an example display according to an embodiment hereof.

FIG. 4 illustrates a diagram of an example computing platform that is remote from a vehicle according to an embodiment hereof.

FIG. 5 illustrates a diagram of an example user device according to an embodiment hereof.

FIG. 6 illustrates an example dataflow pipeline according to an embodiment hereof.

FIG. 7 illustrates an example dataflow pipeline according to an embodiment hereof.

FIG. 8 illustrates an example dataflow pipeline according to an embodiment hereof.

FIG. 9 illustrates a flowchart diagram of an example method according to an embodiment hereof.

FIG. 10 illustrates a diagram of an example computing ecosystem with computing components according to an embodiment hereof.

### DETAILED DESCRIPTION

An aspect of the present disclosure relates to a method, system, and computer program product for customizing computing functions of a vehicle for a user, such as driver or passenger of a vehicle. This is performed by extracting driver behavior from various sensors to understand the driver/passenger's environment, both outside and inside and accordingly, providing a personalized experience. In some instances, this functionality and system may be part of a personal voice assistant system.

For example, a vehicle owner may routinely listen to a certain genre of music, visit a particular coffee shop, or take longer road trips. Each of these actions or behaviors may occur within a context that indicates one or more conditions. For instance, the driver may be on a monotonous or repetitive drive and play uplifting or upbeat music to help the driver maintain focus or attention. In another example, other occupants may play a Christmas music playlist based on the time of year. The occupants may utilize a voice assistant within the vehicle to perform these actions or behaviors. However, machine-learned models are typically trained to generate an output response based on the context received from the input. Thus, unless a driver or passenger includes additional context describing the conditions associated with the verbal command (e.g., input data), the machine-learned model will generate output responses that fail to consider the additional context. Additionally, requiring occupants of the vehicle to describe their sentiment, mood, or other conditions in addition to a verbal command may be impractical or cumbersome to articulate. This may result in the machine-learned model generating inaccurate or unrelated responses.

To address this problem, the technology of the present disclosure utilizes a context engine to enable additional context data associated with the vehicle occupants (e.g., and the vehicle itself) to be considered by machine-learned models. This allows the machine-learned models to personalize the computing function or action associated with the output response. For example, sensors of the vehicle may be used to capture sensor data including, but not limited to, an image of the user, weather data, a current location of the vehicle, or a timestamp associated with the user prompt. The user prompt can include a verbal command from a vehicle occupant that indicates an anticipated response to a statement or a question. While examples described herein discuss verbal or other audio prompts, the present disclosure is not limited to such embodiment, and other forms or non-verbal communication may also be used.

By way of example, a driver may provide a voice input to a Mercedes® virtual assistant running on the vehicle. The voice input can include a prompt such as, “Hey Mercedes®, tell me what's interesting on my drive.” The context engine may analyze the driver and the environment of the vehicle based on dash camera images, location information based on GPS data, and identify unique landmarks, fauna (or other contextual information) using a combination of image data from exterior vehicle cameras and map data. Based on this information, the context engine may modify the prompt to include the additional context of the environment of the vehicle and the conditions (e.g., driver's interest sentiments towards the fauna, etc.) associated with the voice input.

For instance, the context engine may dynamically supplement the voice prompt with additional topics indicative of the context data. Topics may include a sequence of unique tokens that machine-learned models such as machine-learned large language models (LLMs) are trained on. The tokens (e.g., within the sequence of tokens) may represent words, character sets, or phrases that are used by the LLM to decode text into. The context engine, may analyze the context data indicating the one or more conditions (e.g., associated with the occupants and/or the vehicle) and determine supplemental topics to include in the prompt that is processed by the LLM.

For example, the context engine may determine a wildlife topic, or more specifically a “bird” topic based on sensor data capturing images of bird wildlife in the surrounding environment of the vehicle. In an embodiment the particular species of bird may be detected by performing an image analysis. The voice prompt and the supplemental “bird” topic may be input into an LLM such that the LLM may generate an output response to the driver that provides interesting facts about the bird wildlife. In this manner, the context engine personalizes the computing function of the LLM to tailor the user experience of the driver for the particular environment without the driver having to know or describe the fauna in the surrounding environment. Moreover, the context engine and the underlying LLMs may iteratively improve personalization over time. For instance, the modified prompts generated by the context engine and the output responses generated by the LLM may be used for training to detect granular preferences of the driver. The preferences of the user may be stored in a user profile associated with the user and referenced or otherwise accessed by the context engine to determine supplemental topics to include within the modified prompt.

The technology of the present disclosure may improve the energy usage and onboard computing technology of the vehicle. For instance, the vehicle may automatically detect context and conditions associated with input commands and translate the context to data that is interpretable by machine-learned model(s). By way of example, the vehicle's onboard computing system (e.g., context engine within the vehicle computing system) may capture sensor data, identify one or more conditions to generate context data, and concatenate the context data with one or more supplemental topics that can be encoded and processed by an LLM. The vehicle computing system may transmit the supplemental topics and the initial prompt via one or more networks, to an LLM or other system and receive an output response.

By modifying the prompt to provide additional context to the LLM, the vehicle computing may avoid spending its own energy or computing resources to repetitively receive prompts, transmit the user prompts, and receive output responses due to poor quality output responses that fail to consider the context associated with the user's request. This may allow the vehicle to reduce the usage of the vehicle's batteries by reducing the load on the vehicle's onboard computing memory, processing, and communication resources. This allows the vehicle to drive longer and operate its core functions in a more energy-efficient manner.

Moreover, by providing a modified prompt to LLMs, the computing efficiency of LLMs may be increased. For instance, the additional context may facilitate faster processing for LLMs by increasing the efficiency of probability estimations for decoded responses. By way of example, additional context provided to the LLM by way of the modified prompt allows the LLM to have greater confidence and efficiency during the decoding process where, for example, token sequences (e.g., verbal output responses) are determined, song or playlist selection are determined, etc. because the LLMs may rely on additional topics to narrow the candidate tokens that may be associated with a candidate output response.

In some examples, the context engine and the LLMs may be trained to improve the computing customization over time. By way, a context engine may analyze an image of an occupant and determine a sentiment of the user as happy based on the user is smiling. The context engine may predict that a genre of jazz music will complement the occupant's happy sentiment and supplement a prompt requesting music with a jazz topic. The occupant may request a different genre of music such as pop instead of jazz and the context engine may be trained to determine a pop topic when a happy sentiment is detected. For instance, the occupant's preference of pop music when happy may be stored in a user profile associated with the occupant. In this way, the vehicle computing system can more efficiently utilize its computing resources, as well as reduce energy overtime otherwise expended predicting supplemental user topics.

In some implementations, the vehicle computing system may detect routines or patterns of vehicle occupants and suggest or automatically generate prompts on behalf of the occupants. By way of example, a driver may exhibit a routine or set of behaviors of checking the scores for a particular professional sports team each weekend. The particular sports team may be stored in a user profile associated with the driver. Instead of waiting for the driver to provide a prompt each weekend, the vehicle computing system may poll (e.g., continuously or periodically query, etc.) remote computing systems to receive the latest scores for the particular professional sports to anticipate prompts from the driver.

In this manner, the vehicle computing system may proactively provide output responses to the driver without having to receive a prompt. For instance, the vehicle computing system may cache the updated latest score data to provide an immediate output response to the driver. Accordingly, the vehicle computing system may be able to provide a proactive personalized user experience to the driver and reduce computing resources associated with reactively prompting an LLM to generate an output response.

The technology of the present disclosure may include the collection of data associated with a user in the event that the user expressly authorizes such collection. Such authorization may be provided by the user via explicit user input to a user interface in response to a prompt that expressly requests such authorization. Collected data may be anonymized, pseudonymized, encrypted, noised, securely stored, or otherwise protected. A user may opt out of such data collection at any time.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

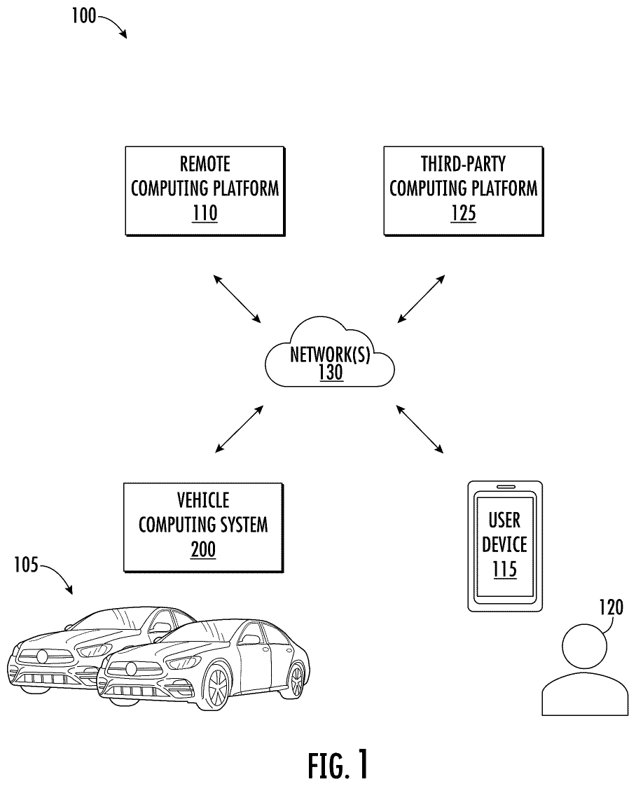

FIG. 1 illustrates an example computing ecosystem 100 according to an embodiment hereof. The ecosystem 100 may include a vehicle 105, a remote computing platform 110 (also referred to herein as computing platform 110), and a user device 115 associated with a user 120. The user 120 may be the owner of the vehicle. In some implementations, the user 120 may be a user intending to operate the vehicle. In some implementations, the computing ecosystem 100 may include a third party (3P) computing platform 125, as further described herein. The vehicle 105 may include a vehicle computing system 200 located onboard the vehicle 105. The computing platform 110, the user device 115, the third party computing platform 125, and/or the vehicle computing system 200 may be configured to communicate with one another via one or more networks 130.

The systems/devices of ecosystem 100 may communicate using one or more application programming interfaces (APIs). This may include external facing APIs to communicate data from one system/device to another. The external facing APIs may allow the systems/devices to establish secure communication channels via secure access channels over the networks 130 through any number of methods, such as web-based forms, programmatic access via RESTful APIs, Simple Object Access Protocol (SOAP), remote procedure call (RPC), scripting access, etc.

The computing platform 110 may include a computing system that is remote from the vehicle 105. In an embodiment, the computing platform 110 may include a cloud-based server system. The computing platform 110 may be associated with (e.g., operated by) an entity. For example, the remote computing platform 110 may be associated with an OEM that is responsible for the make and model of the vehicle 105. In another example, the remote computing platform 110 may be associated with a service entity contracted by the OEM to operate a cloud-based server system that provides computing services to the vehicle 105.

The computing platform 110 may include one or more back-end services for supporting the vehicle 105. The services may include, for example, tele-assist services, navigation/routing services, performance monitoring services, Large Language Models (LLMs) etc. The computing platform 110 may host or otherwise include one or more APIs for communicating data to/from a computing system of the vehicle 105 (e.g., vehicle computing system 200) or the user device 115. The computing platform 110 may include one or more inter-service APIs for communication among its microservices. In some implementations, the computing platform may include one or more RPCs for communication with the user device 115.

The computing platform 110 may include one or more computing devices. For instance, the computing platform 110 may include a control circuit and a non-transitory computer-readable medium (e.g., memory). The control circuit of the computing platform 110 may be configured to perform the various operations and functions described herein. Further description of the computing hardware and components of computing platform 110 is provided herein with reference to other figures.

The user device 115 may include a computing device owned or otherwise accessible to the user 120. For instance, the user device 115 may include a phone, laptop, tablet, wearable device (e.g., smart watch, smart glasses, headphones), personal digital assistant, gaming system, personal desktop devices, other hand-held devices, or other types of mobile or non-mobile user devices. As further described herein, the user device 115 may include one or more input components such as buttons, a touch screen, a joystick or other cursor control, a stylus, a microphone (e.g., voice commands), a camera or other imaging device, a motion sensor (e.g., physical commands), etc. The user device 115 may include one or more output components such as a display device (e.g., display screen), a speaker, etc.

In an embodiment, the user device 115 may include a component such as, for example, a touchscreen, configured to perform input and output functionality to receive user input and present information for the user 120. The user device 115 may execute one or more instructions to run an instance of a software application and present user interfaces associated therewith, as further described herein. In an embodiment, the launch of a software application may initiate a user-network session with the vehicle computing system 200, computing platform 110, etc.

The third-party computing platform 125 may include a computing system that is remote from the vehicle 105, remote computing platform 110, and user device 115. In an embodiment, the third-party computing platform 125 may include a cloud-based server system. The term “third-party entity” may be used to refer to an entity that is different than the entity associated with the remote computing platform 110. For example, as described herein, the remote computing platform 110 may be associated with an OEM that is responsible for the make and model of the vehicle 105. The third-party computing platform 125 may be associated with a supplier of the OEM, a maintenance provider, a mapping service provider, an emergency provider, or other types of entities. In another example, the third-party computing platform 125 may be associated with an entity that owns, operates, manages, etc. a software application that is available to or downloaded on the vehicle computing system 200.

The third-party computing platform 125 may include one or more back-end services provided by a third-party entity. The third-party computing platform 125 may provide services that are accessible by the other systems and devices of the ecosystem 100. The services may include, for example, mapping services, routing services, search engine functionality, maintenance services, entertainment services (e.g., music, video, images, gaming, graphics), emergency services (e.g., roadside assistance, 911 support), open sourced/commercial LLMs, or other types of services. The third-party computing platform 125 may host or otherwise include one or more APIs for communicating data to/from the third-party computing system 125 to other systems/devices of the ecosystem 100.

The networks 130 may be any type of network or combination of networks that allows for communication between devices. In some implementations, the networks 130 may include one or more of a local area network, wide area network, the Internet, secure network, cellular network, mesh network, peer-to-peer communication link or some combination thereof and may include any number of wired or wireless links. Communication over the networks 130 may be accomplished, for instance, via a network interface using any type of protocol, protection scheme, encoding, format, packaging, etc. In an embodiment, communication between the vehicle computing system 200 and the user device 115 may be facilitated by near field or short range communication techniques (e.g., Bluetooth low energy protocol, radio frequency signaling, NFC protocol).

The vehicle 105 may be a vehicle that is operable by the user 120. In an embodiment, the vehicle 105 may be an automobile or another type of ground-based vehicle that is manually driven by the user 120. For example, the vehicle 105 may be a Mercedes-Benz® car or van. In some implementations, the vehicle 105 may be an aerial vehicle (e.g., a personal airplane) or a water-based vehicle (e.g., a boat). The vehicle 105 may include operator-assistance functionality such as cruise control, advanced driver assistance systems, etc. In some implementations, the vehicle 105 may be a fully or semi-autonomous vehicle.

The vehicle 105 may include a powertrain and one or more power sources. The powertrain may include a motor (e.g., an internal combustion engine, electric motor, or hybrid thereof), e-motor (e.g., electric motor), transmission (e.g., automatic, manual, continuously variable), driveshaft, axles, differential, e-components, gear, etc. The power sources may include one or more types of power sources. For example, the vehicle 105 may be a fully electric vehicle (EV) that is capable of operating a powertrain of the vehicle 105 (e.g., for propulsion) and the vehicle's onboard functions using electric batteries. In an embodiment, the vehicle 105 may use combustible fuel. In an embodiment, the vehicle 105 may include hybrid power sources such as, for example, a combination of combustible fuel and electricity.

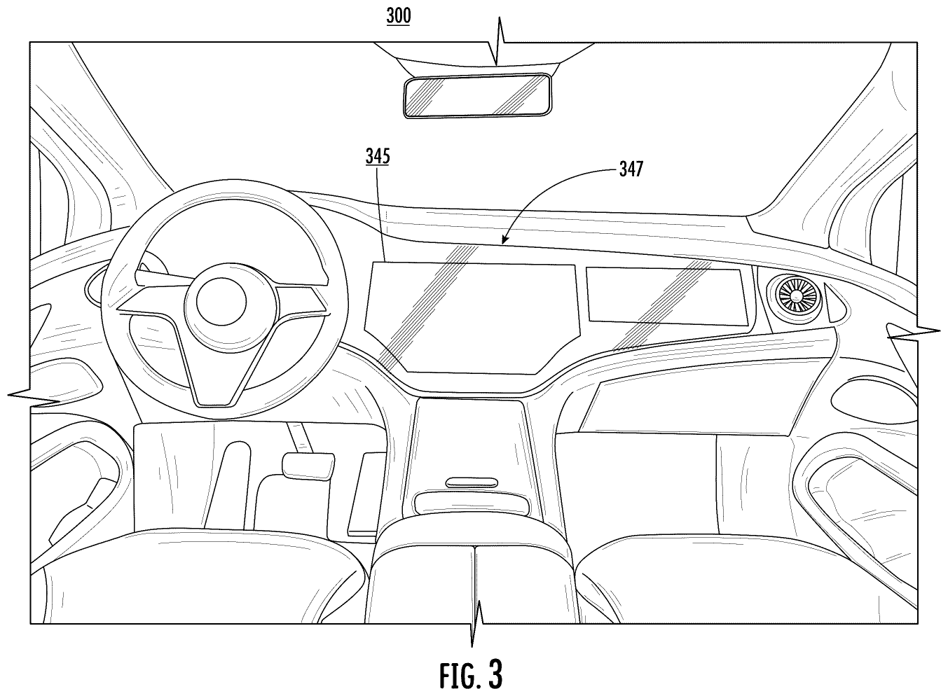

The vehicle 105 may include a vehicle interior. The vehicle interior may include the area inside of the body of the vehicle 105 including, for example, a cabin for users of the vehicle 105. The interior of the vehicle 105 may include seats for the users, a steering mechanism, accelerator interface, braking interface, etc. The interior of the vehicle may include one or more interior vehicle sensors such as imaging sensors, tactile sensors, audio sensors, etc. configured to capture sensor data of vehicle occupants. The interior of the vehicle 105 may include a display device such as a display screen associated with an infotainment system, as further described with respect to FIG. 3.

The vehicle 105 may include a vehicle exterior. The vehicle exterior may include the outer surface of the vehicle 105. The vehicle exterior may include one or more lighting elements (e.g., headlights, brake lights, accent lights). The vehicle 105 may include one or more doors for accessing the vehicle interior by, for example, manipulating a door handle of the vehicle exterior. The vehicle 105 may include one or more windows, including a windshield, door windows, passenger windows, rear windows, sunroof, etc. The vehicle 105 may include one or more sensors for detecting the surrounding environment the vehicle 105. For instance, the vehicle 105 may include one or more camera sensors, temperature/weather sensors, tactile sensors, etc. to objects or conditions within the surrounding environment of the vehicle 105.

The systems and components of the vehicle 105 may be configured to communicate via a communication channel. The communication channel may include one or more data buses (e.g., controller area network (CAN)), on-board diagnostics connector (e.g., OBD-II), or a combination of wired or wireless communication links. The onboard systems may send or receive data, messages, signals, etc. amongst one another via the communication channel.

In an embodiment, the communication channel may include a direct connection, such as a connection provided via a dedicated wired communication interface, such as a RS-232 interface, a universal serial bus (USB) interface, or via a local computer bus, such as a peripheral component interconnect (PCI) bus. In an embodiment, the communication channel may be provided via a network. The network may be any type or form of network, such as a personal area network (PAN), a local-area network (LAN), Intranet, a metropolitan area network (MAN), a wide area network (WAN), or the Internet. The network may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol.

In an embodiment, the systems/devices of the vehicle 105 may communicate via an intermediate storage device, or more generally an intermediate non-transitory computer-readable medium. For example, the non-transitory computer-readable medium 140, which may be external to the computing system, may act as an external buffer or repository for storing information. In such an example, the computing system may retrieve or otherwise receive the information from the non-transitory computer-readable medium 140.

Certain routine and conventional components of vehicle 105 (e.g., an engine) are not illustrated and/or discussed herein for the purpose of brevity. One of ordinary skill in the art will understand the operation of conventional vehicle components in vehicle 105.

The vehicle 105 may include a vehicle computing system 200. As described herein, the vehicle computing system 200 is onboard the vehicle 105. For example, the computing devices and components of the vehicle computing system 200 may be housed, located, or otherwise included on or within the vehicle 105. The vehicle computing system 200 may be configured to execute the computing functions and operations of the vehicle 105.

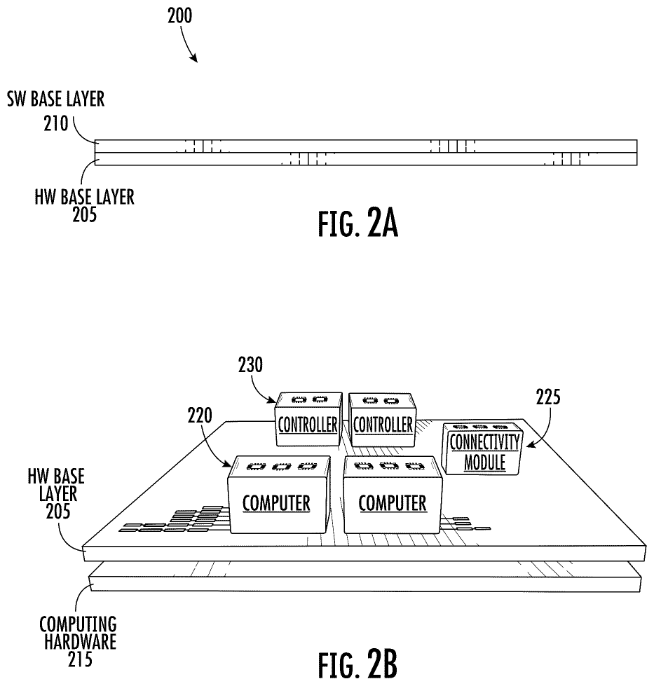

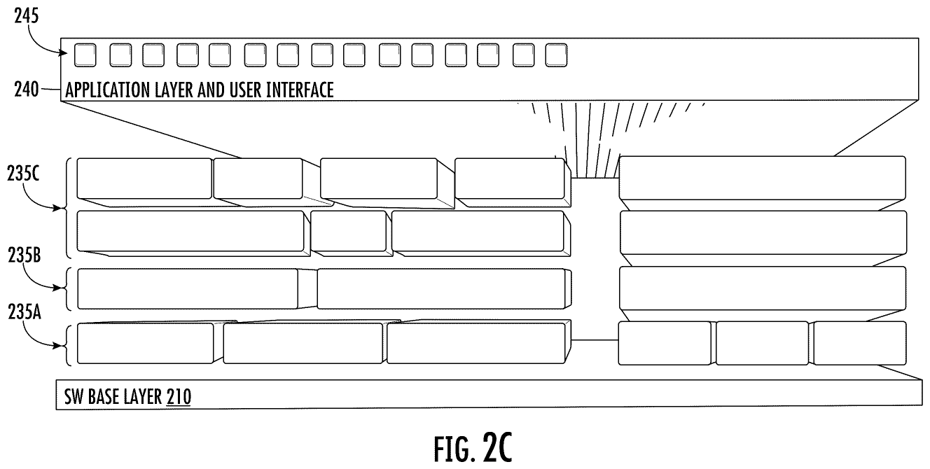

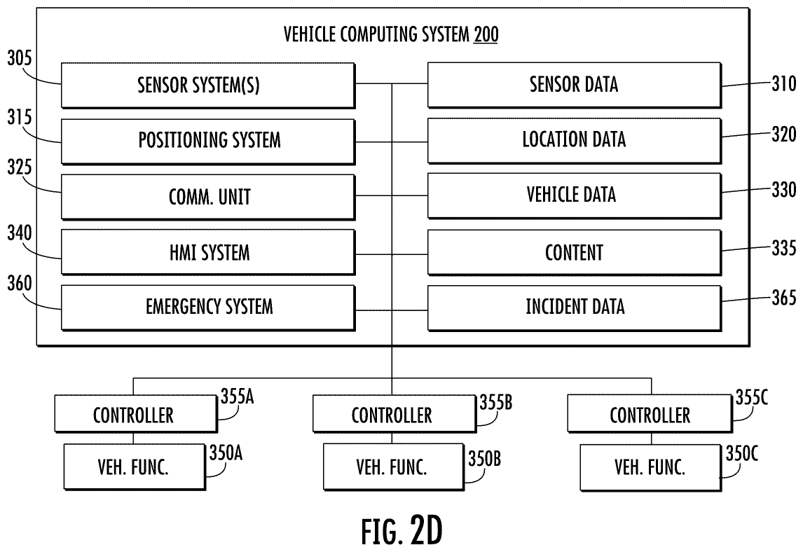

FIG. 2A illustrates an overview of an operating system of the vehicle computing system 105. The operating system may be a layered operating system. The vehicle computing system 200 may include a hardware layer 205 and a software layer 210. The hardware and software layers 205, 210 may include sub-layers. In some implementations, the operating system of the vehicle computing system 200 may include other layers (e.g., above, below, or in between those shown in FIG. 2A). In an example, the hardware layer 205 and the software layer 210 can be standardized base layers of the vehicle's operating system.

FIG. 2B illustrates a diagram of the hardware layer 205 of the vehicle computing system 200. In the layered operating system of the vehicle computing system 200, the hardware layer 205 can reside between the physical computing hardware 215 onboard the vehicle 105 and the software (e.g., of software layer 210) that runs onboard the vehicle 105.

The hardware layer 205 may be an abstraction layer including computing code that allows for communication between the software and the computing hardware 215 in the vehicle computing system 200. For example, the hardware layer 205 may include interfaces and calls that allow the vehicle computing system 200 to generate a hardware-dependent instruction to the computing hardware 215 (e.g., processors, memories, etc.) of the vehicle 105.

The hardware layer 205 may be configured to help coordinate the hardware resources. The architecture of the hardware layer 205 may be serviced oriented. The services may help provide the computing capabilities of the vehicle computing system 105. For instance, the hardware layer 205 may include the domain computers 220 of the vehicle 105, which may host various functionality of the vehicle 105 such as the vehicle's intelligent functionality. The specification of each domain computer may be tailored to the functions and the performance requirements where the services are abstracted to the domain computers. By way of example, this permits certain processing resources (e.g., graphical processing units) to support the functionality of a central in-vehicle infotainment computer for rendering graphics across one or more display devices for navigation, games, etc. or to support an intelligent automated driving computer to achieve certain industry assurances.

The hardware layer 205 may be configured to include a connectivity module 225 for the vehicle computing system 200. The connectivity module may include code/instructions for interfacing with the communications hardware of the vehicle 105. This can include, for example, interfacing with a communications controller, receiver, transceiver, transmitter, port, conductors, or other hardware for communicating data/information. The connectivity module 225 may allow the vehicle computing system 200 to communicate with other computing systems that are remote from the vehicle 105 including, for example, remote computing platform 110 (e.g., an OEM cloud platform).

The architecture design of the hardware layer 205 may be configured for interfacing with the computing hardware 215 for one or more vehicle control units 230. The vehicle control units 230 may be configured for controlling various functions of the vehicle 105. This may include, for example, a central exterior and interior controller (CEIC), a charging controller, or other controllers as further described herein.

The software layer 210 may be configured to provide software operations for executing various types of functionality and applications of the vehicle 105. FIG. 2C illustrates a diagram of the software layer 210 of the vehicle computing system 200. The architecture of the software layer 210 may be service oriented and may be configured to provide software for various functions of the vehicle computing system 200. To do so, the software layer 210 may include a plurality of sublayers 235A-E. For instance, the software layer 210 may include a first sublayer 235A including firmware (e.g., audio firmware) and a hypervisor, a second sublayer 235B including operating system components (e.g., open-source components), and a third sublayer 235C including middleware (e.g., for flexible integration with applications developed by an associated entity or third-party entity).

The vehicle computing system 200 may include an application layer 240. The application layer 240 may allow for integration with one or more software applications 245 that are downloadable or otherwise accessible by the vehicle 105. The application layer 240 may be configured, for example, using containerized applications developed by a variety of different entities. By way of example, the application layer 240 may include containerized LLMs.

The layered operating system and the vehicle's onboard computing resources may allow the vehicle computing system 200 to collect and communicate data as well as operate the systems implemented onboard the vehicle 105. FIG. 2D illustrates a block diagram of example systems and data of the vehicle 105.

The vehicle 105 may include one or more sensor systems 305. A sensor system 305 may include or otherwise be in communication with a sensor of the vehicle 105 and a module for processing sensor data 310 associated with the sensor configured to acquire the sensor data 305. This may include sensor data 310 associated with the surrounding environment of the vehicle 105, sensor data associated with the interior of the vehicle 105, or sensor data associated with a particular vehicle function. The sensor data 310 may be indicative of conditions observed in the interior of the vehicle, exterior of the vehicle, or in the surrounding environment. For instance, sensors of the vehicle 105 may include exterior sensors for detecting objects or motion within a surrounding environment of the vehicle 105. Sensor data 310 may include image data, data indicative of a vehicle occupant (e.g., user 120, etc.) within or outside the vehicle 105, positions of a user/object within a threshold distance of the vehicle 105, motion/gesture data, audio data, temperature data, tactile data, or other types of data. The sensors may include one or more: cameras (e.g., visible spectrum cameras, infrared cameras), motion sensors, tactile sensors, audio sensors (e.g., microphones), weight sensors (e.g., for a vehicle a seat), temperature sensors, humidity sensors, Light Detection and Ranging (LIDAR) systems, Radio Detection and Ranging (RADAR) systems, or other types of sensors.

The vehicle 105 may include a positioning system 315. The positioning system 315 may be configured to generate location data 320 (also referred to as position data) indicative of a location (also referred to as a position) of the vehicle 105. For example, the positioning system 315 may determine location by using one or more of inertial sensors (e.g., inertial measurement units, etc.), a satellite positioning system, based on IP address, by using triangulation and/or proximity to network access points or other network components (e.g., cellular towers, WiFi access points, etc.), or other suitable techniques. The positioning system 315 may determine a current location of the vehicle 105. The location may be expressed as a set of coordinates (e.g., latitude, longitude), an address, a semantic location (e.g., “at work”), etc.

In an embodiment, the positioning system 315 may be configured to localize the vehicle 105 within its environment. For example, the vehicle 105 may access map data that provides detailed information about the surrounding environment of the vehicle 105. The map data may provide information regarding: the identity and location of different roadways, road segments, buildings, or other items; the location and directions of traffic lanes (e.g., the location and direction of a parking lane, a turning lane, a bicycle lane, or other lanes within a particular roadway); traffic control data (e.g., the location, timing, or instructions of signage (e.g., stop signs, yield signs), traffic lights (e.g., stop lights), parking restrictions, or other traffic signals or control devices/markings (e.g., cross walks)); or any other data. The positioning system 315 may localize the vehicle 105 within the environment (e.g., across multiple axes) based on the map data. For example, the positioning system 155 may process certain sensor data 310 (e.g., LIDAR data, camera data, etc.) to match it to a map of the surrounding environment to get an understanding of the vehicle's position within that environment. The determined position of the vehicle 105 may be used by various systems of the vehicle computing system 200 or another computing system (e.g., the remote computing platform 110, the third-party computing platform 125, the user device 115).

The vehicle 105 may include a communications unit 325 configured to allow the vehicle 105 (and its vehicle computing system 200) to communicate with other computing devices. The vehicle computing system 200 may use the communications unit 325 to communicate with the user device 115 or one or more other remote computing devices over a network 130 (e.g., via one or more wireless signal connections). For example, the vehicle computing system 200 may utilize the communications unit 325 to transmit prompts and receive output responses from the LLM systems remote from the vehicle 105. This may include, for example, one or more prompts, modified prompts etc. transmitted (e.g., over the one or more networks 130) and one or more output responses associated with actions executable by the vehicle computing system 200. For instance, the output response may include, but is not limited to emitting an audio response via one or more vehicle speakers, generating/updating a user interface display within the vehicle 105, adjusting a temperature setting within the vehicle 105, providing an entertainment suggestion, providing a destination suggestion, adjusting a comfort setting with the vehicle 105, etc. An example of vehicle user interface displays is further described with reference to FIG. 3.

Additionally, or alternatively, the vehicle computing system 200 may utilize the communications unit 325 to send vehicle data 335 (e.g., prompts, modified prompts, context data etc.) to the user device 115. The vehicle data 335 may include any data acquired onboard the vehicle 105 including, for example, sensor data 310, location data 320, user input data, or other types of data obtained (e.g., acquired, accessed, generated, downloaded, etc.) by the vehicle computing system 200. For instance, LLMs accessible to the user device 115 may be used to process prompts from the user 120.

In some implementations, the communications unit 325 may allow communication among one or more of the systems on-board the vehicle 105.

In an embodiment, the communications unit 325 may utilize various communication technologies such as, for example, Bluetooth low energy protocol, radio frequency signaling, or other short range or near filed communication technologies. The communications unit 325 may include any suitable components for interfacing with one or more networks, including, for example, transmitters, receivers, ports, controllers, antennas, or other suitable components that may help facilitate communication.

The vehicle 105 may include one or more human-machine interfaces (HMIs) 340. The human-machine interfaces 340 may include a display device, as described herein. The display device (e.g., touchscreen) may be viewable by a user of the vehicle 105 (e.g., user 120) that is located in the front of the vehicle 105 (e.g., driver's seat, front passenger seat). Additionally, or alternatively, a display device (e.g., rear unit) may be viewable by a user that is located in the rear of the vehicle 105 (e.g., back passenger seats). The human-machine interfaces 340 may present content via a user interface for display to a user 120.

FIG. 3 illustrates an example vehicle interior 300 with a display device 345. The display device 345 may be a component of the vehicle's infotainment system. Such a component may be referred to as a display device of the infotainment system or be considered as a device for implementing an embodiment that includes the use of an infotainment system. For illustrative and example purposes, such a component may be referred to herein as a head unit display device (e.g., positioned in a front/dashboard area of the vehicle interior), a rear unit display device (e.g., positioned in the back passenger area of the vehicle interior), an infotainment head unit or rear unit, or the like. The display device 345 may be located on, form a portion of, or function as a dashboard of the vehicle 105. The display device 345 may include a display screen, CRT, LCD, plasma screen, touch screen, TV, projector, tablet, and/or other suitable display components.

The display device 345 may display a variety of content to the user 120 including information about the vehicle 105, prompts for user input, outputs in response to user prompts, etc. The display device 345 may include a touchscreen through which the user 120 may provide user input to a user interface.

For example, the display device 345 may include user interface rendered via a touch screen that presents various content. The content may include vehicle speed, mileage, fuel level, charge range, navigation/routing information, audio selections, streaming content (e.g., video/image content), internet search results, comfort settings (e.g., temperature, humidity, seat position, seat massage), or other vehicle data 335. The display device 345 may render content to facilitate the receipt of user input. For instance, the user interface of the display device 345 may present one or more soft buttons with which a user 120 can interact to adjust various vehicle functions (e.g., navigation, audio/streaming content selection, temperature, seat position, seat massage, etc.). Additionally, or alternatively, the display device 345 may be associated with an audio input device (e.g., microphone) for receiving audio input from the user 120.

Returning to FIG. 2D, the vehicle 105 may include an emergency system 360. The emergency system 360 may be configured to obtain incident data 365. The incident data 365 may be indicative of an incident event including the vehicle 105. For example, the incident data 365 may include sensor data 310 from one or more sensors such as an airbag sensor, an impact sensor configured to detect an impact to the vehicle 105 by another object, a sensor configured to detect damaged vehicle components, a sensor configured to detect broken wired or wireless connections, etc. The incident event may include an accident, collision with an object (e.g., other vehicle, tree, guard rail), an unsafe vehicle maneuver (e.g., rollover, swerve offroad), etc. In some implementations, the emergency system 360 may be included in the communications system 325.

The vehicle 105 may include a plurality of vehicle functions 350A-C. A vehicle function 350A-C may be a functionality that the vehicle 105 is configured to perform based on a detected input. The vehicle functions 350A-C may include one or more: (i) vehicle comfort functions; (ii) vehicle staging functions; (iii) vehicle climate functions; (vi) vehicle navigation functions; (v) drive style functions; (v) vehicle parking functions; or (vi) vehicle entertainment functions. The (vi) vehicle entertainment functions may include playing music playlists or interactions with a travel companion. A travel companion can include a virtual or digital system such as a voice assistant that engages in communications with the vehicle occupants during the duration of a drive. For instance, the user 120 may interact with a vehicle function 250A-C through user input (e.g., to voice prompt) that specifies a setting of the vehicle function 250A-C such as the (i) vehicle entertainment function causing an LLM running within the vehicle computing system 200 or remote from the vehicle computing system 200 to engage in a dialogue with the vehicle occupants.

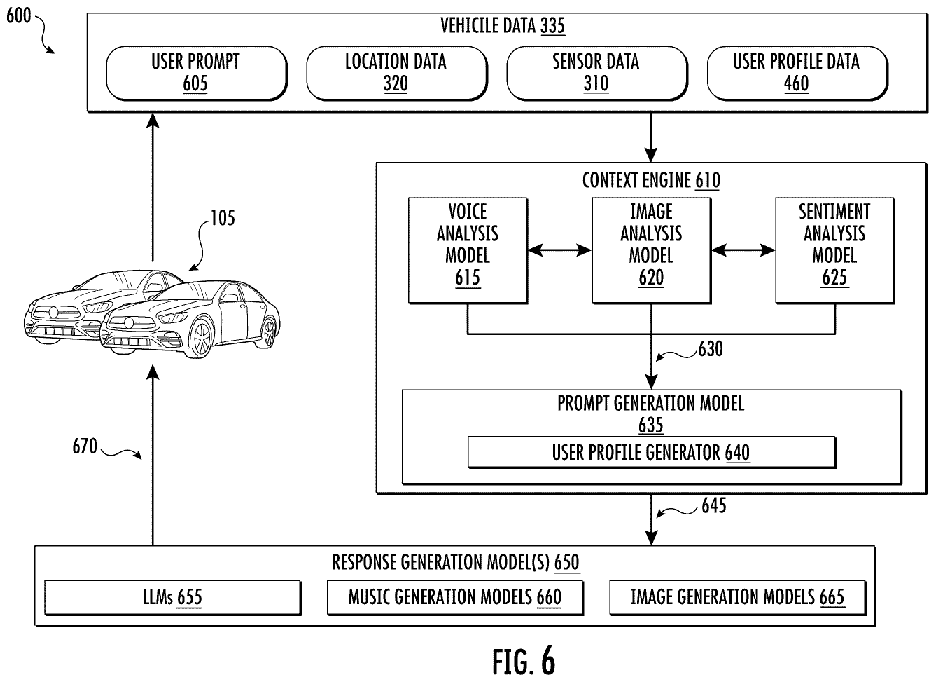

In an embodiment, the vehicle functions 350A-C may be functionality implemented in response to a model output (e.g., LLM output) based on a prompt or modified prompt from a vehicle occupant. For instance, the vehicle owner may request, via a voice command, suggestions for dinner. A context engine may capture context data associated with one or more conditions of the voice command and generate a modified voice command that is transmitted to and processed by an LLM. The LLM may return an output response that is implemented as a vehicle function 350A-C. An example of a context engine facilitating modified voice commands is further described with reference to FIGS. 6-8.

Each vehicle function may include a controller 355A-C associated with that particular vehicle function 350A-C. The controller 355A-C for a particular vehicle function may include control circuitry configured to operate its associated vehicle function 350A-C. For example, a controller may include circuitry configured to unlock a door, turn on the ignition, turn the seat heating function on, to turn the seat heating function off, set a particular temperature or temperature level, etc.

In an embodiment, a controller 355A-C for a particular vehicle function may include or otherwise be associated with a sensor that captures data indicative of the vehicle function being turned on or off, a setting of the vehicle function, etc. For example, a sensor may be an audio sensor or a motion sensor. The audio sensor may be a microphone configured to capture audio input from the user 120. For example, the user 120 may provide a voice command to activate the radio function of the vehicle 105 and request a particular station. The motion sensor may be a visual sensor (e.g., camera), infrared, RADAR, etc. configured to capture a gesture input from the user 120. For example, the user 120 may provide a hand gesture motion to adjust a temperature function of the vehicle 105 to lower the temperature of the vehicle interior.

The controllers 355A-C may be configured to send signals to another onboard system. The signals may encode data associated with a respective vehicle function. The encoded data may indicate, for example, a function setting, timing, etc. In an example, such data may be used to generate content for presentation via the display device 345 (e.g., showing a current setting). In another example, such data may be used to by a context engine to supplement user behaviors such as voice prompts with additional context. Additionally, or alternatively, such data can be included in vehicle data 335 and transmitted to the remote computing platform 110.

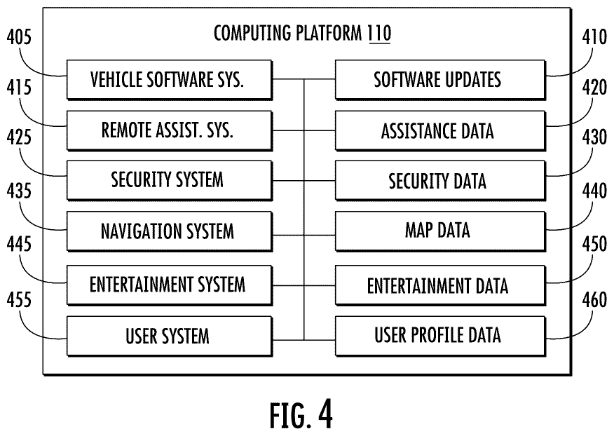

FIG. 4 illustrates a diagram of computing platform 110, which is remote from a vehicle according to an embodiment hereof. As described herein, the computing platform 110 may include a cloud-based computing platform.

In some implementations, the computing platform 110 may be implemented on a server, combination of servers, or a distributed set of computing devices which communicate over a network (e.g., network 130). For instance, the computing platform 110 may be distributed using one or more physical servers, private servers, or cloud computing. In some examples, the computing platform 110 may be implemented as a part of or in connection with one or more microservices, where, for example, an application is architected into independent services that communicate over APIs. Microservices may be deployed in a container (e.g., standalone software package for a software application) using a container service, or on VMs (virtual machines) within a shared network. Example, microservices may include a microservice associated with the vehicle software system 405, remote assistance system 415, etc. A container service may be a cloud service that allows developers to upload, organize, run, scale, manage, and stop containers using container-based virtualization to orchestrate their respective actions. A VM may include virtual computing resources which are not limited to a physical computing device. In some examples, the computing platform 110 may include or access one or more data stores for storing data associated with the one or more microservices. For instance, data stores may include distributed data stores, fully managed relational, NoSQL, and in-memory databases, etc.

The computing platform 110 may include a remote assistance system 415. The remote assistance system 415 may provide assistance to the vehicle 105. This can include providing information to the vehicle 105 to assist with charging (e.g., charging locations recommendations), remotely controlling the vehicle 105 (e.g., for AV assistance), remotely accessing the vehicle 105 (e.g., remote authorizations), roadside assistance (e.g., for collisions, flat tires), etc. The remote assistance system 415 may obtain assistance data 420 to provide its core functions. The assistance data 420 may include information that may be helpful for the remote assistance system 415 to assist the vehicle 105. This may include information related to the vehicle's current state, an occupant's current state, the vehicle's location, the vehicle's route, charge/fuel level, incident data, etc. In some implementations, the assistance data 420 may include the vehicle data 335.

The remote assistance system 415 may transmit data or command signals to provide assistance to the vehicle 105. This may include providing data indicative of relevant charging locations, remote control commands to move the vehicle, personalized recommendations, etc.

The computing platform 110 may include a security system 425. The security system 425 can be associated with one or more security-related functions for accessing the computing platform 110 or the vehicle 105. For instance, the security system 425 can process security data 430 for identifying vehicle occupancy, data encryption, data decryption, etc. for accessing the services/systems of the computing platform 110. Additionally, or alternatively, the security system 425 can store security data 430 associated with the vehicle 105. A user 120 can request authorization to access or operate the vehicle 105 (e.g., by approaching the vehicle 105, touching the vehicle, voice commands, etc.). In the event the user 120 has a magnetic key for the vehicle 105 as indicated in the security data 430, the security system 425 can provide a signal to perform one or more vehicle functions 350A-C based on a predetermined authorization profile associated with the magnetic key.

The computing platform 110 may include a navigation system 435 that provides a back-end routing and navigation service for the vehicle 105. The navigation system 435 may provide map data 440 to the vehicle 105. The map data 440 may be utilized by the positioning system 315 of the vehicle 105 to determine a location of the vehicle 105, a point of interest, etc. The navigation system 435 may also provide routes to destinations requested by the vehicle 105 (e.g., via user input to the vehicle's head unit). The routes can be provided as a portion of the map data 440 or as separate routing data. Data provided by the navigation system 435 can be presented as content on the display device 345 of the vehicle 105. In an embodiment, personalized destinations may be determined by the navigation system 435 based on output responses from an LLM. For instance, a context engine may detect additional context indicating conditions associated with a request for suggested destination. The context engine may facilitate personalized responses by communicating with an LLM to generate an output response that considers the additional context. The output response can be implemented by causing the navigation system 435 to provide routes to personalized destinations that consider the additional context.

The computing platform 110 may include an entertainment system 445. The entertainment system 445 may access one or more databases for entertainment data 450 for a user 120 of the vehicle 105. In some implementations, the entertainment system 445 may access entertainment data 450 from another computing system associated with a third-party service provider of entertainment content. The entertainment data 450 may include media content such as music, videos, gaming data, etc. The entertainment data 450 may be provided to vehicle 105, which may output the entertainment data 450 as content via one or more output devices of the vehicle 105 (e.g., display device, speaker, etc.). In an embodiment, the entertainment system 445 may facilitate a travel companion experience for the user 120 during the duration of a trip.

The computing platform 110 may include a user system 455. The user system 455 may create, store, manage, or access user profile data 460. The user profile data 460 may include a plurality of user profiles, each associated with a respective user 120. A user profile may indicate various information about a respective user 120 including the user's preferences (e.g., for music, comfort settings, parking preferences), frequented/past destinations, past routes, etc. The user profiles may be stored in a secure database. In some implementations, when a user 120 enters the vehicle 105, the user's key (or user device 115) may provide a signal with a user or key identifier to the vehicle 105.

The vehicle 105 may transmit data indicative of the identifier (e.g., via its communications system 325) to the computing platform 110. The computing platform 110 may look-up the user profile of the user 120 based on the identifier and transmit user profile data 460 to the vehicle computing system 200 of the vehicle 105. The vehicle computing system 200 may utilize the user profile data 460 to implement preferences of the user 120, present past destination locations, etc. In an embodiment, the user profile data 460 may be used by a context engine to generate modified prompts which considers the preferences of the user 120. The user profile data 460 may be updated based on information periodically provided by the vehicle 105. In some implementations, the user profile data 460 may be provided to the user device 115.

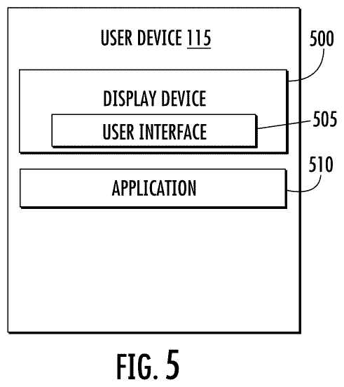

FIG. 5 illustrates a diagram of example components of user device 115 according to an embodiment hereof. The user device 115 may include a display device 500 configured to render content via a user interface 505 for presentation to a user 120. The display device 500 may include a display screen, AR glasses lens, smart watch, CRT, LCD, plasma screen, touch screen, TV, projector, tablet, or other suitable display components. The user device 115 may include a software application 510 that is downloaded and runs on the user device 115. In some implementations, the software application 510 may be associated with the vehicle 105 or an entity associated with the vehicle 105 (e.g., manufacturer, retailer, maintenance provider). In an example, the software application 510 may enable the user device 115 to communicate with the computing platform 110 and the services thereof.

The user device 115 may be configured to pair with the vehicle 105 via a short-range wireless protocol. The short-range wireless protocol may include, for example, at least one of Bluetooth®, Wi-Fi, ZigBee, UWB, IR. The user device 115 may pair with the vehicle 105 through one or more known pairing techniques. For example, the user device 115 and the vehicle 105 may exchange information (e.g., IP addresses, device names, profiles) and store such information in their respective memories. Pairing may include an authentication process whereby the user 120 validates the connection between the user device 115 and the vehicle 105. In some examples, the user device 115 may be configured to pair with the vehicle 105 over one or more networks 130 such as the internet. For instance, the user device 115 may be remote from the vehicle 105 and pair with the vehicle 105 over a network 130.

Once paired, the vehicle 105 and the user device 115 may exchange signals, data, etc. through the established communication channel. For example, the head unit 347 of the vehicle 105 may exchange signals with the user device 115.

The technology of the present disclosure allows the vehicle computing system 200 to preserve its computing resources by obtaining sensor data 305 and utilizing a context engine to generate personalized prompts. The personalized prompts may be input into one or more machine-learned models to generate personalized output responses for users 120. This allows the user 120 to provide prompts or hands free commands to the vehicle 105 and experience a personalized action. Examples described herein reference a vehicle owner as a vehicle occupant that may prompt a digital voice assistant within the vehicle 105. This is meant for example purposes only and is not meant to be limiting. Other parties associated with the vehicle 105 may provide prompts and other forms of communicating prompts may be used. This can include users 120 that are outside the vehicle, users 120 that type messages via the user device 115, display device 345, etc. or communicate using gestures such as sign language, etc. For instance, the user 120 may provide prompts via the user device 115.

As described herein, this technology can overcome potential inefficiencies introduced by omitting context data associated with such prompts and iteratively providing output responses that lack the requisite context to provide a personalized user experience within the vehicle 105. By way of example, existing LLMs which operate as part of a third-party service (e.g., third-party computing platform 125) may be stateless. A stateless LLM may process each prompt as a standalone interaction without remembering past or previous interactions. This can create complexities in generating personalized user experiences because previous interactions may not be considered when decoding a future response. Aspects of the present disclosure allow even stateless LLMs to generate personalized output responses by providing the LLM with additional context (e.g., by way of a modified prompt) to influence the LLM to generate an output response that is tailored to the user 120 or circumstances.

FIG. 6 illustrates an example dataflow pipeline according to an embodiment hereof. The following description of dataflow in data pipeline 600 is described with an example implementation in which a context engine 610 processes vehicle data 335 from the vehicle 105 and causes one or more response generation models 650 to generate output responses 670 that implement actions within the vehicle 105 for the user 120 or other vehicle occupants. The vehicle data 335 may include real-time data and/or training data. Example real-time data may include cabin audio data captured by microphones placed strategically throughout the vehicle interior 300. Training data may include pre-trained dataset from commercially available fine-tuned LLMs with automotive-specific vocabular, scenarios, etc. For instance, the context engine may be pre-trained using training vehicle data and continuously train on real-time vehicle data.

The context engine 610 may be software running on one or more servers. For instance, the context engine 610 may include software running on one or more servers within the vehicle computing system 200, the remote computing platform 110, the user device 115, or the third-party computing platform 125. In an embodiment, the context engine 610 may include a standalone system that communicates with the vehicle 105 and the response generation models 650 over a network (e.g., network 130). In other embodiments, the context engine 610 may be a response generation model 650.

The context engine 610 may include one or more machine-learned models that process vehicle data 335 to generate output indicative of modified prompts 645 which can be processed by response generation models 650. For instance, the context engine 610 may include a voice analysis model 615, an image analysis model 620, and a sentiment analysis model 625 configured to process vehicle data 335 and generate context data 630. Moreover, the context engine 610 may include a prompt generation model 635 configured to receive the context data 630 and generate one or more modified prompts 645 that can be processed by the response generation models 650.

While examples herein describe sub-models of the context engine 610 as being distinct from each other and distinct from the response generation models 650, the present disclosure is not limited to such embodiment and the functionality of each component described herein may be combined, omitted, or otherwise included in a singular or multiple systems. Moreover, while examples herein describe the context engine 610 as being deployed remote from the vehicle computing system 200, the present disclosure is not limited to such embodiment and the context engine 610, response generation models 650, and/or any of the elements described may be included within the vehicle computing system 200 of the vehicle 1065.

For instance, the context engine 610 and/or any of the response generation models 650 may be deployed on edge computing devices within the vehicle 105 and leverage cloud infrastructure (e.g., remote computing platform 110, third-party computing platform 125, etc.) for updates, training, or other processing tasks. In an embodiment, the hybrid architecture of running the context engine 610 and/or any of the response generation models 650 across the vehicle computing system 200 of the vehicle 105 and the cloud infrastructure approach may ensure low latency and scalability, while also allowing for real-time data processing.

The voice analysis model 615 may be an unsupervised or supervised learning model configured to detect the tone, emotion, or intent of a voice command from vehicle occupant. In some examples, the voice analysis model 615 may include one or more machine-learned models. For example, the voice analysis model 615 may include a machine-learned model trained to analyze the tone, emotion, and intent behind a voice prompt (e.g., user prompt 605). In some examples, the voice analysis model 615 may include a machine-learned model trained to detect the speech content included within the user prompt 605. In other examples, the voice analysis model 615 may include a machine-learned model trained to distinguish multiple occupants of the vehicle 105 from each other by executing audio segmentation techniques.

The voice analysis model 615 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The voice analysis model 615 may be trained through the use of one or more model trainers and training data. The model trainers may be trained using one or more training or learning algorithms. One example training technique is backwards propagation of errors. Another example building and training technique is employing TensorFlow and PyTorch. In some examples, simulations may be implemented for obtaining the training data or for implementing the model trainer(s) for training or testing the model(s). In some examples, the model trainer(s) may perform supervised training techniques using labeled training data. As further described herein, the training data may include labelled audio segments that have labels indicating users 120, intent expressions, etc. In some examples, the training data may include simulated training data (e.g., training data obtained from simulated scenarios, inputs, configurations, various acoustic settings, etc.). In some examples, the training may include noise-cancellation training and reinforcement learning for refining command recognition accuracy. Other examples may include using hyperparameters such as learning rate, batch size, and optimizing epochs using grid search and Bayesian optimization techniques.

Additionally, or alternatively, the model trainer(s) may perform unsupervised training techniques using unlabeled training data. By way of example, the model trainer(s) may train one or more components of a machine-learned model to perform voice detection and voice analysis through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The voice analysis model 615 may process the audio data included in the user prompt 605 and identify the occupant of the vehicle that provided the user prompt 605. For instance, the user prompt 605 may be any form of communication that can be converted into an input text. Example forms of communication may include verbal or audio communications, hand gestures, user input provided to user interface elements, etc. The voice analysis model 615 may receive a user prompt 605 which includes a statement or question directed to a voice assistant running within the vehicle computing system 200 of the vehicle 105.

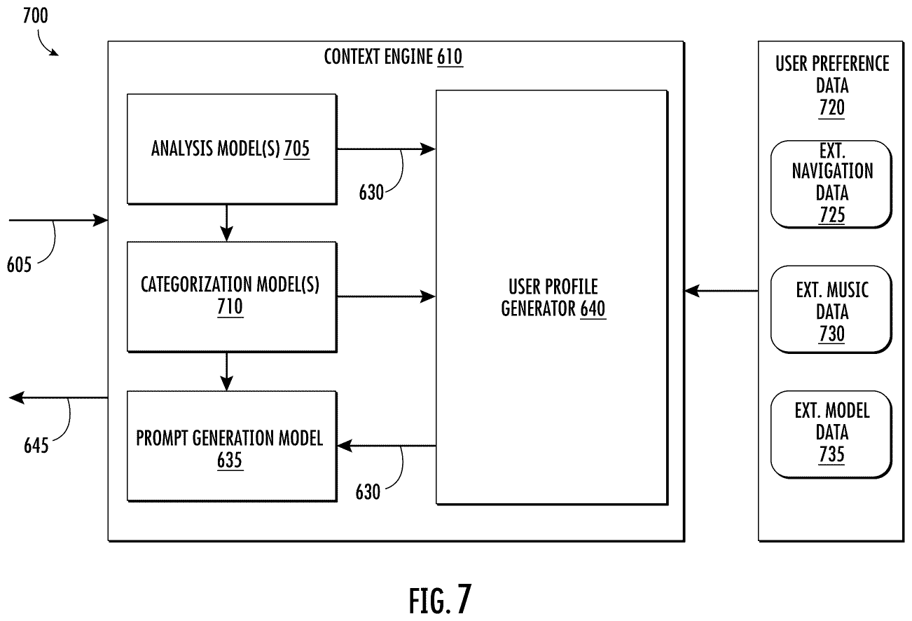

In an example embodiment, a driver/passenger in the vehicle 105 may provide a voice input (e.g. a voice query) user prompt 605 to a personal voice assistant system of the vehicle 105 to generate music. The personal voice assistant may include one or more processors/processing circuits that are configured to perform a transcription, speech recognition, and/or speech-to-text function. By way of example, one or more microphones within the vehicle interior 300 may capture the user prompt 605 from the driver of the vehicle 105. The voice analysis model 615 may receive the voice input and identify the source (e.g., driver, other occupants, etc.) based on a voice analysis. In an embodiment, the voice analysis model 615 may be trained to detect a user prompt 605 and associate the source of the user prompt 605 with user profile data 460. For instance, the user profile data 460 may store identity information (e.g., image, voice, etc.) for the user 120, associated user preferences, etc. and provide additional context to the user prompt 605. An example of using user preferences to add additional context to a user prompt 605 is further described with reference to FIG. 7.

The voice analysis model 615 may be trained to analyze the user prompt 605 and detect the tone, emotion, or intent of user 120. By way of example, the user 120 may use a monotone voice based on being tired or anxious. The voice analysis model 615 may be trained to detect such tones based on voice inflection, volume, etc. In an embodiment, the voice analysis model 615 may generate context data 630 based on the voice analysis indicating the tone, emotion, or intent of the user 120. The context data 630 may be utilized by the prompt generation model 635 to generate a modified prompt 645.

The voice analysis model 615 may additionally and/or alternatively interact with the image analysis model 620 to detect and identify tones, emotions, or intent of the user 120. In an embodiment, the voice analysis model 615 may additionally and/or alternatively interact with the image analysis model 620 to reinforce predicted tones, emotions, or intent of the user 120. For instance, the image analysis model 620 may process sensor data 310 including images or video data of the user 120 who provided the user prompt 605. In an embodiment, the voice analysis model 615 and the image analysis model 620 may communicate (e.g., over network 130) to identify the user 120 which provided the user prompt 605 to determine and/or reinforce the tone, emotion, or intent of user 120.

The image analysis model 620 may be an unsupervised or supervised learning model configured to detect the identity of the user 120 and determine the tone, emotion, or intent of a user prompt 605 from a vehicle occupant. In some examples, the image analysis model 620 may include one or more machine-learned models. For example, the image analysis model 620 may include a machine-learned model trained to analyze sensor data 310 including, but not limited to image data, video data, etc. In some examples, the image analysis model 620 may include a machine-learned model trained to detect the speech content included within video data that includes the user prompt 605. In other examples, the image analysis model 620 may include a machine-learned model trained to distinguish multiple occupants of the vehicle 105 from each other by executing image segmentation techniques.

The image analysis model 620 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The image analysis model 620 may be trained through the use of one or more model trainers and training data. The model trainers may be trained using one or more training or learning algorithms. One example training technique is backwards propagation of errors. Another example building and training technique is employing TensorFlow and PyTorch. In some examples, simulations may be implemented for obtaining the training data or for implementing the model trainer(s) for training or testing the model(s). In some examples, the model trainer(s) may perform supervised training techniques using labeled training data. As further described herein, the training data may include labelled image frames that have labels indicating users 120, intent expressions, etc. In some examples, the training data may include simulated training data (e.g., training data obtained from simulated scenarios, inputs, configurations, various settings, etc.). In some examples, the training may include image segmentation training and reinforcement learning for refining user recognition accuracy. Other examples may include using hyperparameters such as learning rate, batch size, and optimizing epochs using grid search and Bayesian optimization techniques.

Additionally, or alternatively, the model trainer(s) may perform unsupervised training techniques using unlabeled training data. By way of example, the model trainer(s) may train one or more components of a machine-learned model to perform object detection and object classification through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The image analysis model 620 may access sensor data 310 including image frames of occupants of the vehicle 105 and process the image frames to detect the one or more occupants. By way of example, sensor data 310 may include an image of the driver of the vehicle 105 captured by a dashcam or other camera within the vehicle interior 300. The image of the driver can be analyzed by the image analysis model 620 to detect and determine the identity of the driver. For instance, the image analysis model 620 project a bonding shape onto the image frame of the driver. The bounding shape may be any shape (e.g., polygon) that includes one or more users 120. In an embodiment, the bounding shape may include a shape that matches the outermost boundaries and contours of those boundaries for a user 120. One of ordinary skill in the art will understand that other shapes may be used such as squares, circles, rectangles, etc. In some implementations, the bounding shape may be generated on a per pixel level. The space characteristics may include the x, y, z coordinates of the bounding shape center, the length, width, and height of the bounding shape, etc.

The image analysis model 620 may generate data (e.g., labels) that correspond to the characteristics of the bounding shape. Labels may indicate the user 120 (e.g., identity of the user), user characteristics such as mood, tone, or intent (e.g., based on facial expressions, eye movements, etc.), position/orientation, etc. In an embodiment, the image analysis model 620 may detect a plurality of vehicle occupants in addition to the user 120. For instance, the image analysis model 620 may iteratively project bounding shapes on each detected occupant or perform segmentation techniques to process image segments concurrently or sequentially to identify each of the vehicle occupants and identify contextual information such as the mood, tone, or intent of each. The image analysis model 620 may generate context data 630 based on identified characteristics of the users 120 depicted in the sensor data 310.

In an embodiment, the image analysis model 620 may concatenate detected vehicle occupants with user profile data 460. For instance, users 120 identified by their image (e.g., or voice) may be associated with corresponding user profile data 460 which includes user preferences or other historical data associated with the user 120. By way of example a passenger of the vehicle may have user profile data 460 based on previously operating the vehicle 105. Sensor data 310, user prompts 605 and other data may be stored in as user profile data 460 such that when the passenger subsequently returns to the vehicle 105 vehicle configurations, vehicle actions, user prompts 605, etc. may be accessible as historical contextual information for the passenger. In an embodiment, the context data 630 generated by the image analysis model may include the user profile data 460.

In some embodiments, the voice analysis model 615 and the image analysis model 620 may jointly generate context data 630. For instance, the context engine 610 may concatenate voice analysis data from the voice analysis model 615 and image analysis data from the image analysis model 620. The fused data outputs may be used to jointly identify the user 120 which provided the user prompt 605 and detect mood, tones, or intent of the user 120. In this manner, the context engine 610 may consider a plurality of sensor modalities to extract conditions associated with the user prompt 605.

The sentiment analysis model 625 may be used to generate sentiment data. Sentiment data may determine or otherwise categorize the sentiments of the user 120 by considering all conditions associated with the user prompt 605. For instance, the sentiment analysis model 625 may analyze vehicle data and model outputs (e.g., voice analysis model 615, image analysis model 620, etc.) to determine one or more sentiments of the user 120. The sentiments may be categorized and mapped to one or more topics. For instance, the sentiment analysis model 625 may determine based on the vehicle data 335 and model outputs that the sentiment of the user 120 is excited and generate context data 630 that provides contextual information of the user being excited to the prompt generation model 635.

The sentiment analysis model 625 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The sentiment analysis model 625 may be trained through the use of one or more model trainers and training data. The model trainers may be trained using one or more training or learning algorithms. One example training technique is backwards propagation of errors. Another example building and training technique is employing TensorFlow and PyTorch. In some examples, simulations may be implemented for obtaining the training data or for implementing the model trainer(s) for training or testing the model(s). In some examples, the model trainer(s) may perform supervised training techniques using labeled training data. As further described herein, the training data may include labelled image frames, labeled datasets for noise-cancellation training and reinforcement learning for refining command recognition accuracy, and/or audio segments, etc., that have labels indicating a category of the users' 120 sentiment.

The training dataset may include diverse audio samples from different car environments and driving conditions, ensuring robust performance across various scenarios. In some examples, the training data may include simulated training data (e.g., training data obtained from simulated scenarios, inputs, configurations, various settings, etc.). In some examples, the training may include noise-cancellation training and reinforcement learning for refining command recognition accuracy. Other examples may include using hyperparameters such as learning rate, batch size, and optimizing epochs using grid search and Bayesian optimization techniques.

Additionally, or alternatively, the model trainer(s) may perform unsupervised training techniques using unlabeled training data. By way of example, the model trainer(s) may train one or more components of a machine-learned model to perform sentiment detection and classification through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The sentiment analysis model 625 may access outputs from the voice analysis model 615 and image analysis model 620 to generate sentiment data. Sentiment data may include a perceived sentiment of the user 120 such as a mood, feeling, or tone of the user within context. Context may include one or more conditions associated with the user 120 or the surrounding environment of the vehicle 105. For instance, the sentiment analysis model 625 may access the location data 320 which includes a current location of the vehicle 105 at a particular time (e.g., timestamp, etc.), sensor data 310 which includes sensor data captured by exterior sensors and interior vehicle sensors, the user prompt 605, and output analysis from the voice analysis model 615 and the image analysis model 620.

The sentiment analysis model 625 may determine a sentiment of the user 120 within the context of one or more conditions surrounding the user prompt 605. By way of example, the driver through a voice input may provide a command saying, “Hey Mercedes®, generate a good instrumental jazz”. The sentiment analysis model 625 may extract the driver's location (e.g., based on the location data 320), previous destination where the driver has traveled to (e.g., based on user profile data 460), and determine a mood of the driver based on voice analysis data, image analysis data, etc., and based on the outside environment. For instance, sensor data 310 may include data captured from exterior vehicle sensors that indicate raining weather conditions. Based on the one or more conditions (e.g., location, previous destinations, voice and/or image analysis, outside environment, etc.) the sentiment analysis model 625 may determine a sentiment of the user 120 within the context of the conditions in which the user prompt was provided. In this manner, the sentiment analysis model 625 may reason over all conditions associated with the user 120 and the vehicle 105 to determine a sentiment of the user 120.

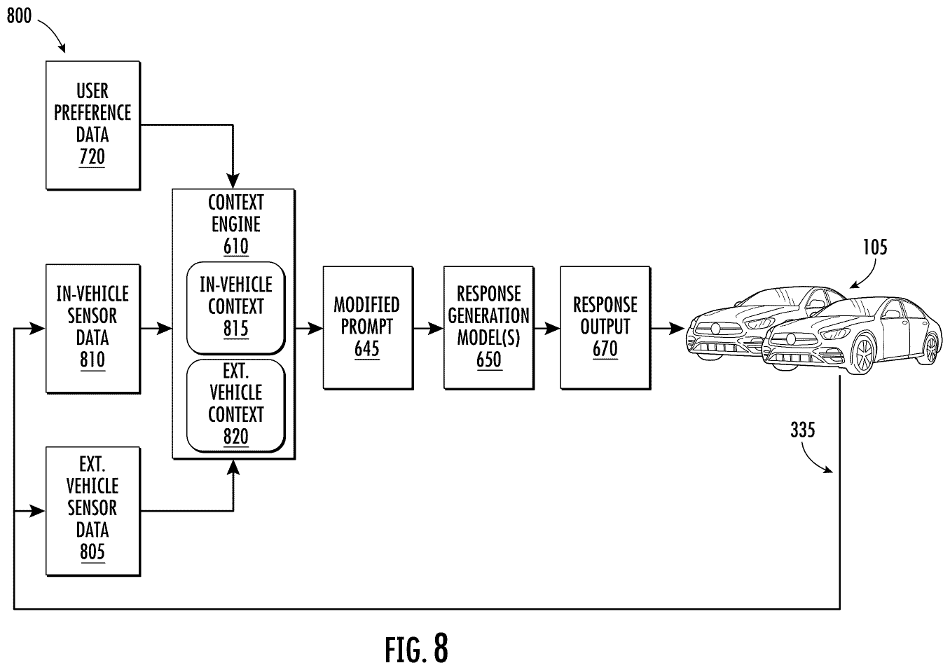

For instance, sentiment data may include an environmental sentiment. An environmental sentiment can include emotions or feelings invoked by nature or the surrounding environment of the vehicle. For instance, a beautiful sunset on a scenic route may invoke positive emotions as opposed to a cold, gray, or rainy day which may invoke neutral or negative emotions. The sentiment analysis model 625 may analyze sensor data 310 captured by external sensor of the vehicle 105 to predict an environmental sentiment. An example of the different categories of sentiments is further discussed with reference to FIGS. 7-8.

The sentiment analysis model 625 may generate context data 630 which includes sentiment data. The sentiment data may be stored as user profile data 460 indicating the sentiment of the user 120 at the particular location, timestamp, and associated interior and exterior conditions of the user prompt 605. In this manner, the sentiment analysis model 625 may generate a training dataset which may be used to further train the sentiment analysis model 625 to better predict the sentiment of each individual occupant of the vehicle 105. The sentiment analysis model 625 may generate context data 630 which includes the sentiment data indicating an associated sentiment category.

For example, the associated sentiment category may be associated with one or more supplemental topics that provide additional context to the prompt generation model 635. The prompt generation model 635 may receive the context data 630 from the voice analysis model 615, image analysis model 620, and/or the sentiment analysis model 625 concurrently, sequentially, or iteratively during a trip. For instance, the sentiment data indicating the sentiment of the user 120 may change over the course of a trip.

The prompt generation model 635 may receive the context data 630 and/or the sentiment data and generate a modified prompt 645. The modified prompt 645 may supplement the user prompt 605 with the context data 630 such that the one or more conditions (e.g., tone, mood, intent, sentiment, environmental factors, etc.) associated with the user prompt 605 may be provided to the response generation models 650.

The prompt generation model 635 may include one or more sub-systems. For instance, the prompt generation model 635 may include a user profile generator 640. The user profile generator 640 may concatenate the user profile data 460 with user preference data external to the vehicle computing system 200. For instance, the user 120 may interact with remote computing systems 200 within the vehicle 105. By way of example, the user may listen to music streaming platforms or applications, external navigation applications, etc. while operating the vehicle 105. The user profile generator 640 may concatenate user profile data 460 specific to the vehicle computing system 200 such as comfort settings, previous destinations, etc., with user preferences configured in external systems. An example of the user profile generator 640 is further described with reference to FIG. 7.

The prompt generator model 635 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The prompt generator model 635 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include token sequences, predetermined prompts, etc., that indicate acceptable modifications to a user prompt 605. In some examples, the training data may include simulated training data (e.g., training data obtained from simulated scenarios, inputs, configurations, various settings, etc.).

Additionally, or alternatively, the model trainer(s) may perform unsupervised training techniques using unlabeled training data. By way of example, the model trainer(s) may train one or more components of a machine-learned model to perform sentiment detection and classification through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The prompt generation model 635 may receive the context data 630 and in response to the context data 630 and determine one or more supplemental topics that represent the additional context (e.g., one or more conditions) associated with the user prompt 605. For instance, the prompt generation model 635 may receive the user prompt 605 and the context data 630 to determine one or more supplemental topics that may be added to the user prompt 605. The supplemental topics may provide additional context surrounding the user 120 or the vehicle. In some embodiments, the prompt generation model 635 may parameterize the response generation models 650 to generate contextually aware response outputs. Parameterizing the response generation models 650 may include modifying the probability estimations for tokens decoded into a sequence of tokens that include the output response 670. For instance, the prompt generation model 635 may output one or more parameters that are applied to the response generation models 650 to influence the selection of tokens (e.g., words, phrases, etc.) that are included as a part of the response output to the user 120.

By way of example, the prompt generation model 635 may receive the user prompt 605 indicating the user 120 asked “Hey Mercedes®, what's that on my right?” and based on the context data 630 indicating conditions such as the user is driving through highway one, is near Morro bay and a flock of seagulls is flying on the right over the Morro rock (e.g., vehicle conditions). For this, the user's intent or sentiment may be determined to be “inquisitive” (e.g., user conditions). The prompt generation model 635 may supplement the user prompt 605 with a supplemental topic associated with volcanoes or more specifically a volcanic rock. The prompt generation model 635 may modify the user prompt 605 to include additional topics. For instance, the modified prompt 645 may include “Hey Mercedes®, what's this volcanic rock on highway one near Morro Bay?” such that the response generation models 650 may generate an output response 670 that is contextually aware of the user's surroundings by considering additional context that was not previously included in the user prompt 605.

In an embodiment, the prompt generator model 635 may parameterize one or more response generation models 650 based on the context data 630. For instance, in the previous example, the prompt generation model 635 may provide the user prompt 605 and one or more parameters that influence the response generation models 650 to generate an output response 670 that discusses volcanic rock. By way of example, the parameters may modify a probability estimation of the response generation models 650 that makes tokens related to volcanic rock more likely to be included in the output response 670 than words related to other topics. In this manner, the prompt generation model 635 may influence the response generation models 650 to generate more personalized output responses. Other methods of influencing the response generation models 650 may also be used such as, but not limited to steering vectors or other training techniques.

The response generation models 650 may receive the modified prompt 645 and generate an output response 670. The output response 670 may include one or more computing instructions that, when received by the vehicle computing system 200 of the vehicle 105 cause the vehicle 105 to perform one or more actions corresponding to the user prompt 605. Additionally, or alternatively, an additional program or system may utilize the output response 670 as input and process it to determine instructions that are executable by the appropriate vehicle systems to perform the action(s) corresponding to the user prompt 605.

For instance, the output response 670 may include emitting an audio response, updating a user interface (e.g., display device 345, etc.) within the vehicle 105, adjusting a temperature setting within the vehicle 105, providing an entertainment suggestion, providing a destination suggestion, or adjusting a comfort setting (e.g., seat settings, etc.) within the vehicle 105. The vehicle computing system 200 may utilize one or more vehicle controllers 355A to perform one or more vehicle functions 350A-C associated with the output response 670.

The response generation models 650 may include a one or more machine-learned models configured to generate an output response 670 in response to a user prompt 605 (e.g., or modified prompt 645). For instance, the response generation models 650 may include large language models (LLMs) 655, music generation models 660, and image generation models 665. LLMs 655 may include machine-learned models which can perform a variety of natural language processing (NLP) tasks such as, for example, tasks to recognize, translate, predict, or generate text or other content. Music generation models 660 may include machine-learned models that can analyze large datasets of sounds and identify related or complementary sounds. Image generation models 665 may include machine-learned models that may create high-quality imagery through text or image prompts.

The response generation models 650 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The response generation models 650 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include text data, audio data, image data, etc. In some examples, the training data may include simulated training data (e.g., training data obtained from simulated scenarios, inputs, configurations, various settings, etc.).

Additionally, or alternatively, the model trainer(s) may perform unsupervised training techniques using unlabeled training data. By way of example, the model trainer(s) may train one or more components of a machine-learned model to perform sentiment detection and classification through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The response generation models 650 may receive the modified prompt 645 and generate an output response 670. By way of example, the user 120 may engage in a continuous conversation with a travel companion voice assistant after receiving a response regarding the ancient volcanic plug to the user's right. For instance, the user 120 may respond to the initial output response 670 indicating the Morro rock and provide a subsequent user prompt requesting that the travel companion “tell me about my drive”. The user prompt 605 indicating the continuation of the conversation with the voice assistant may be received by the context engine 610 and processed in a similar manner as the initial user prompt 605. In an embodiment, the machine-learned models within the context engine 610 may update one or more parameters based on the subsequent user prompt 605. For instance, the substance and context of the subsequent user prompt 605 may provide a feedback look to confirm the accuracy of the model's predictions. In this manner the context engine 610 may be incrementally trained over the course of a conversation or multiple conversations with the user 120.

The prompt generation model 635 may consider the previous output response 670 and subsequent user prompt along with the additional context data 630 to generate a modified prompt 645. For instance, the user 120 may have displayed (e.g., via sensor data 310, voice analysis, image analysis, etc.) increased curiosity in the environment of the vehicle 105 based on the initial response output 670. The prompt generation model 635, in response to the additional context data 630 and the previous output response 670 describing the volcanic rock, may modify the user prompt 605 to “tell me more about my environment” to further personalize the conversation. In this manner, the prompt generation model 635 may generate a modified prompt 645 which influences the response generation models 650 from generating duplicative output responses (e.g., repetitive volcanic rock responses, etc.). For instance, the response generation models 650 may receive the subsequent modified user prompt and generate an output response 670 describing “the flock of birds you see on your right, are native to the Morro bay and are attracted here for fishing the abundance of anchovies that breed here. This place is also home to a lot of otters that can be seen floating near the shore.” The user 120 and other vehicle occupants may iteratively provide user prompts 605 and receive personalized output responses 670.

In an embodiment, an automated user prompt 605 may be generated by the context engine 610 and cause the response generation models 650 to generate an output response 670 without input from the user 120 or other vehicle occupants. For instance, the context engine 610 may passively receive vehicle data 335 including location data 320, sensor data 310, and user profile data 460. The voice analysis model 615, image analysis model 620, and the sentiment analysis model 625 may passively process the vehicle data 335 to continuously determine the context data 630 associated with the trip and anticipate user prompts 605 from the user or other vehicle occupants.

By way of example, a driver may repeatedly enter the vehicle 105 after picking up a companion from work, adjust comfort settings, and play a first playlist. Over time, the context engine (e.g., analysis models) may learn to detect the sequence of behaviors by the driver and generate a user prompt 605 which request the modification of the comfort settings and initiation of the first playlist. However, additional conditions may also be detected to automatically generate modified user prompts 605.

For instance, on days when the weather is rainy or cold, the driver may additionally adjust the comfort settings for the companion and play a second playlist. For instance, the sentiment analysis model 625 may determine the companion dislikes rainy or cold weather and based on the driver adjustments automatically modify the automated prompt to initiate the second playlist to improve the sentiment of the companion.

In response to the additional context of rainy or cold weather, the context engine 610 may modify the automated user prompt 605 and generate an automated modified prompt 645 which includes the additional context. In this manner, the context engine 610 can anticipate and further personalize the experience of the user 120 over time.

FIG. 7 depicts an example dataflow pipeline according to an embodiment hereof. The following description of dataflow in data pipeline 700 is described with an example implementation in which the context engine 610 accesses user preference data 720 and utilizes the user profile generator 640 to concatenate outputs from the analysis models 705 and categorization models 710. The user profile generator 640 may generate context data 630 that may be used by the prompt generator model 635 to generate modified user prompts 645.

In this embodiment, the context engine 610 may include one or more analysis models 705 and one or more categorization models 710. The analysis models 705 may include, or include similar models to, the voice analysis model 615, the image analysis model 620, and the sentiment analysis model 625. For instance, the analysis model 705 may include one or more machine-learned models configured to process vehicle data 335, detect, extract, and/or determine one or more conditions associated with a user prompt 605 as described in FIG. 6.

The categorization models 710 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The categorization models 710 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include any of the data described herein. In some examples, the training data may include simulated training data (e.g., training data obtained from simulated scenarios, inputs, configurations, various settings, etc.).

Additionally, or alternatively, the model trainer(s) may perform unsupervised training techniques using unlabeled training data. By way of example, the model trainer(s) may train one or more components of a machine-learned model to perform sentiment detection and classification through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The categorization models 710 may include one or more machine-learned models configured to categorize the output of the analysis model 705 into one or more categories. For instance, the categorization models 710 may receive context data 630 output from the analysis models 705 and categorize the context data 630 as in-vehicle context data or exterior vehicle context data. In-vehicle context data may include context data associated with the user 120 (e.g., driver, owner, other vehicle occupants), or components of the vehicle interior 300. For instance, sentiment data indicating the sentiment of the user 120 may be categorized as in vehicle context data. Conversely exterior vehicle context data may include environmental conditions such as weather conditions, scenic routes, objects in the environment, etc. For instance, the environmental sentiment may be categorized as exterior vehicle sentiment. In this manner the categorization models 710 may modularize the context data such that the prompt generation model may more accurately determine supplemental topics or parameters to output to the response generation models. Moreover, the granular context data may facilitate additional training of the machine-learned models to more accurately generate personalized output responses based on the impact an environmental sentiment may have on a human user 120. An example of utilizing in-vehicle and exterior vehicle context data is further described with reference to FIG. 8.

In an embodiment, the context engine 610 may include a user profile generator 640. The user profile generator 640 may be included as a standalone system, a portion of the prompt generation model 635, or any components of the models (e.g., analysis models 705, categorization models 710, etc.). The user profile generator 640 may include software configured to receive user preference data 720 from one or more remote computing systems (e.g., third-party computing platform 125, etc.) and concatenate the user preference data 720 with use profile data 460 associated with the user 120 that provided the user prompt 605.

The user preference data 720 may include external user preference data from one or more computing systems or platforms that are external to the vehicle computing system 200. For instance, the user preference data 720 may include external navigation data 725, external music data 730, and external model data 735. External navigation data 725 may include data from one or more navigation applications which indicate information such frequently visited places, favorite or saved destinations, preferred routes, etc. External music data 730 may include data from one or more external music platforms which indicate information such as saved playlists, top songs, favorites genres, etc. External model data 735 may include data from one or more external machine-learned models that have been trained using data associated with the user 120.

For instance, voice assistants which operate on the user device 115 may store or otherwise include additional user preferences of the user 120 within our outside of the vehicle. In this manner, the user preference data 720 can supplement the user profile data 460 to include additional information about the user's preferences. While examples herein describe external navigation data 725, external music data 730, and external model data 735, the present disclosure is not limited to such embodiment and any data associated with the user 120 that is captured or processed externally to the vehicle computing system 200, may be utilized.

In an embodiment, the user profile generator 640 may be configured to concatenate the user preference data 720 with the context data 630 output from the analysis models 705. For instance, the user profile generator 640 may generate a user profile identifier for a user 120 which serves as key to associate user preference data 720 from external systems with user profile data 460 associated with the user 120. The user profile identifier may be an extensible token included within the modified prompt 645 which identifies the user 120 and authorizes the modified user prompt to be processed by the response generation models 650. For instance, the user profile identifier may enable the response generation models 650 to access the user preference data 720 and the user profile data associated with the user 120 as a corpus for selecting tokens or a sequence of tokens to include in the output response 670.

By way of example, analysis models 705 may output context data 630 including user profile data 460. The context data 630 may indicate one or more conditions associated with the user prompt. In an embodiment, the context data 630 may be categorized by the categorization models 710 indicating whether the context data is related to in-vehicle context or exterior vehicle context. The user profile generator 640 may receive the context data 630 (and/or categorized context data) and concatenate user preference data 720. For instance, in vehicle context data may indicate that the user 120 had a saddened sentiment, is operating the vehicle in the rain, and navigating to a secluded park. The user profile generator may generate a user profile identifier that concatenates the external navigation data 725 from a frequently used navigation application by the user 120 that is remote from the vehicle computing system and the external music data 730 indicating the user's 120 favorite playlists or songs. In an embodiment, the user profile generator 640 may generate a new data structure which appends the user profile data 460 to include the user preference data 720.

The user profile generator 640 may supplement the context data 630 with the user preference data 720 such that the user profile generator 640 may output context data that includes both the context data 630 based on the vehicle data 335 and the user preference data 720. The user profile generator 640 may output the supplemented context data 630 to the prompt generation model 635 to provide additional information. The prompt generation model 635 may utilize the supplemented context data 630 to generate modified user prompts 645. For instance, the prompt generation model 635 may additionally consider the user preference data 720 in determining one or more topics to supplement the user prompt 605. In the manner, the context engine 610 may cause the response generation models to generate highly personalized output responses 670 by considering not only the conditions associated with the user prompt 605, but also the preferences of the user 120 beyond the vehicle 105.

FIG. 8 depicts an example dataflow pipeline according to an embodiment hereof. The following description of dataflow in data pipeline 800 is described with an example implementation in which an example response output 670 is generated for a user 120 in a vehicle 105 using user preference data 720, in-vehicle context 815, and exterior vehicle context 820.

In the example dataflow pipeline 800, a vehicle occupant may provide vehicle data 335 including a user prompt 605 to a voice assistant running on the vehicle computing system 200. For instance, the vehicle occupant may provide a voice command requesting music to be played during the drive. The vehicle data 335 may include sensor data 310 captured in response to, or concurrently, with the voice command. The sensor data 310 may include data captured from interior vehicle and exterior vehicle sensors. For instance, the vehicle data 335 may include exterior vehicle sensor data 805 and interior vehicle sensor data 810 captured at a threshold timestamp associated with the user prompt 605. For example, the exterior vehicle sensor data 805 and the interior vehicle sensor data 810 may be captured within a threshold time of three seconds, five seconds, etc. before or after the user prompt 605 was received. In an embodiment, the exterior vehicle sensor data 805 and the interior vehicle sensor data 810 may be captured concurrently (e.g., identical timestamp) with the user prompt.

By way of example, the in-vehicle and exterior vehicle sensors may capture sensor data associated with the surrounding environment of the vehicle 105 and the vehicle interior 300. For instance, the sensor data may include images of the user 120 before, during, and after the user prompt 605 was received, weather data indicating a sunny day, a location of the vehicle 105 indicating the user 120 is “at home”, and a timestamp indicating 8 AM. The in-vehicle senor data 810 and exterior vehicle sensor data 805 may be included in the vehicle data 335 and transmitted to the context engine 610 for processing.

In an embodiment, the user preference data 720 may be accessed by the context engine 610 to obtain additional contextual information associated with the user prompt 605. The context engine 610 may utilize one or more machine-learned models (e.g., analysis models 705, categorization models 710, etc.) to process the exterior vehicle sensor data 805, the interior vehicle sensor data 810, and the user preference data to generate in-vehicle context 815 and exterior vehicle context 820.

For example, the analysis models 705 may process the in-vehicle sensor data 810. The in-vehicle sensor data 810 may indicate that the user has an excited sentiment, has entered an address into a remote navigation platform, and was listening to a playlist on the preceding trip from a remote music platform. The context engine 610 may access user preference data 720 to identify the address entered as “work” and the previous playlist as a “afternoon commute” playlist.

The analysis models 705 may also process the exterior vehicle sensor data 805. For instance, the exterior vehicle sensor data 805 may indicate sunny weather along the route from the “home” to “work”. Based on the exterior vehicle sensor data 805, the interior vehicle sensor data 810, and the user preference data 720, the context engine 610 may generate in-vehicle context 815 and exterior vehicle context 820 indicating that the user 120 will be traveling to work from home, is in an excited mood, and will experience a positive environmental sentiment along the route. Furthermore the context engine 610 may determine based on the user preference data 720 that the user 120 typically listens to a “morning commute” playlist to stay energized on the trip to “work”.

Based on the in-vehicle context 815 and the exterior vehicle context 820, the context engine 610 may generate a modified prompt 645 that modifies the initial user prompt 605. For instance the modified prompt 645 may instead request that the “morning commute” playlist and similar music be played from the remote music platform during the duration of the trip. The modified prompt 645 may be input into a response generation model 650. For instance, a music generation model 660 may receive the modified prompt 645 and generate an output response 670 which causes the vehicle computing system 200 to play (e.g., via the interior speakers) the “morning commute” playlist and similar music during the trip from “home” to “work”. In this manner, the context engine 610 may supplement the user prompt 605 with the context data to provide the “morning commute” conditions associated with the user prompt 605.

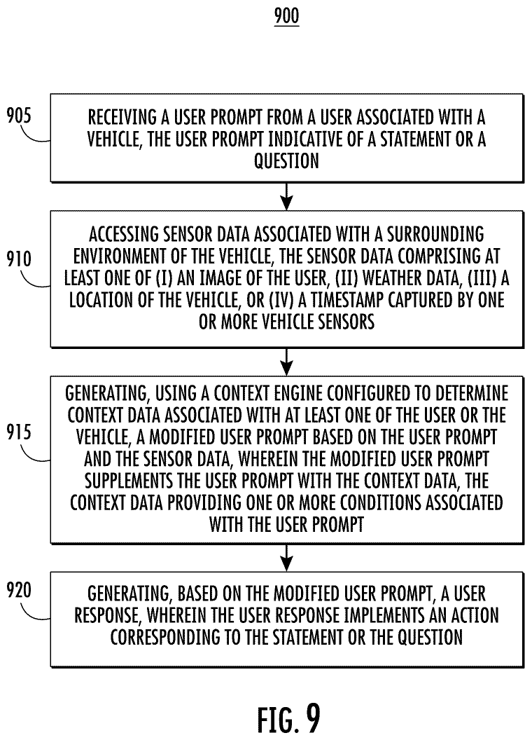

FIG. 9 illustrates a flowchart diagram of an example method 900 for personalizing a user experience to an embodiment hereof. The method 900 may be performed by a computing system described with reference to the other figures. In an embodiment, the method 900 may be performed by the control circuit of a vehicle computing system 200 of FIG. 1. One or more portions of the method 900 may be implemented as an algorithm on the hardware components of the devices described herein. For example, the steps of method 900 may be implemented as operations/instructions that are executable by computing hardware.

FIG. 9 illustrates elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 9 is described with reference to elements/terms described with respect to other systems and figures, for example illustrated purposes and is not meant to be limiting. One or more portions of method 900 may be performed additionally, or alternatively, by other systems. For example, method 900 may be performed by a control circuit of the user device 115.

In an embodiment, the method 900 may begin with or otherwise include an operation 905: receiving a user prompt from a user associated with a vehicle, the user prompt indicative of a statement or a question. For instance, the user 120 may provide a voice command that is received by a microphone or other interior sensor within the vehicle 105.

The method 900 in an embodiment may include an operation 910: accessing sensor data associated with a surrounding environment of the vehicle, the sensor data comprising at least of (i) an image of the user, (ii) weather data, (iii) a location of the vehicle, or (iv) a timestamp captured by one or more vehicle sensors. For instance, the vehicle computing system 200 may capture sensor data 310 within a threshold time associated with the user prompt 605. The sensor data 310 may be exterior vehicle sensor data 805 or interior vehicle sensor data 810 captured by one or more sensors of the vehicle 105. The sensor data 310 and user prompt 605 may be included in vehicle data 335 that is transmitted over one or more networks 130 to a context engine 610.

The method 900 in an embodiment may include an operation 915: generating, using a context engine configured to determine context data associated with at least one of the user or the vehicle, a modified user prompt based on the user prompt and the sensor data, wherein the modified user prompt supplements the user prompt with the context data, the context data providing one or more conditions associated with the user prompt. For instance, the context engine 610 may process the vehicle data 335 including the user prompt 605 and the sensor data 310 using analysis models 705, categorization models 710, etc., to generate context data 630. The context data 630 may be in-vehicle context 815 or exterior vehicle context 820 and indicate one or more conditions within the vehicle or outside of the vehicle that may be associated with the user prompt 605.

The prompt generation model 635 may receive the context data 630 and generate a modified prompt 645 which supplements the user prompt 605 with one or more topics that represent the one or more internal or external conditions. For instance, the prompt generation model 635 may change tokens, add tokens, or remove tokens to the user prompt 605 that is encoded and input into the response generation models 650. The modified prompt 645 may provide additional context to user prompt 605 such that the response generation models 650 may access additional information when determining an output response 670.

For example, the modified prompt 645 may cause the response generation models 650 to consider additional topics that would have otherwise been omitted from the output response. By way of example, the modified prompt 645 may include additional topics that modifies a probability distribution within the response generation models 650 that causes the response generation models 650 to generate an output response that considers the additional context associated with the user prompt 605.

The method 900 in an embodiment may include an operation 920: generating, based on the modified user prompt, a user response, wherein the user response implements an action corresponding to the statement or the question. For instance, The response generation models 650 may receive the modified prompt 645 and generate an output response 670 based on the one or more conditions indicated by the context data 630. The output response 670 may be transmitted (e.g., over one or more networks 130) to the vehicle computing system 200. In response to the output response 670, the vehicle computing system 200 may implement (e.g., via a controller 355A-C) an action corresponding to the user prompt 605.

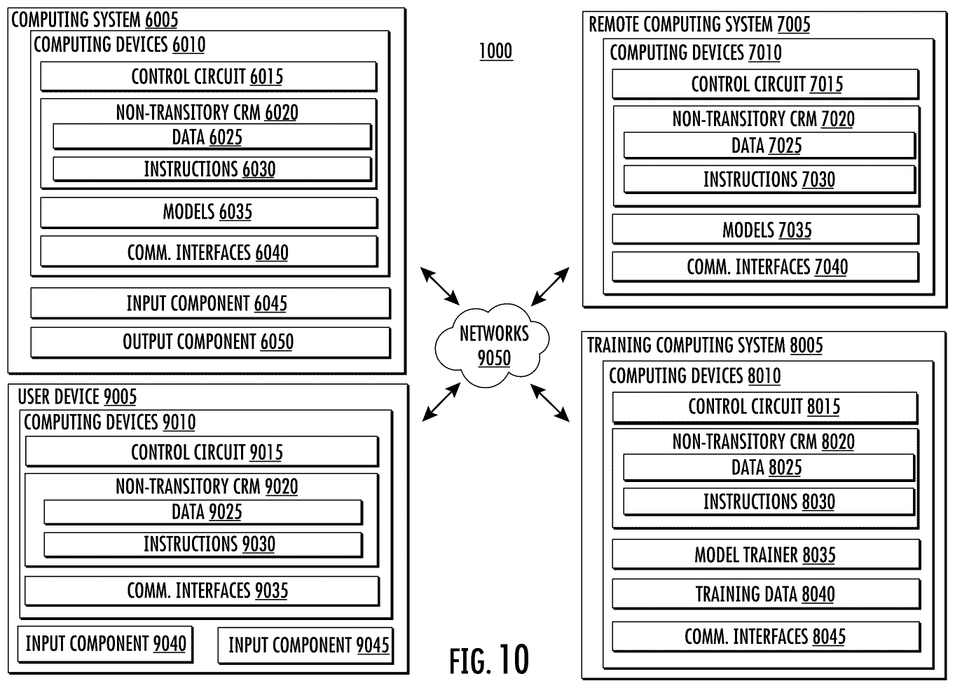

FIG. 10 illustrates a block diagram of an example computing system 1000 according to an embodiment hereof. The system 1000 includes a computing system 6005 (e.g., a computing system onboard a vehicle), a remote computing system 7005 (e.g., computing platform 110), a user device 9005 (e.g., user device 115), and a training computing system 8005 that are communicatively coupled over one or more networks 9050.

The computing system 6005 may include one or more computing devices 6010 or circuitry. For instance, the computing system 6005 may include a control circuit 6015 and a non-transitory computer-readable medium 6020, also referred to herein as memory. In an embodiment, the control circuit 6015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 6015 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a charging controller, a central exterior & interior controller (CEIC), a zone controller, or any other controller. In an embodiment, the control circuit 6015 may be programmed by one or more computer-readable or computer-executable instructions stored on the non-transitory computer-readable medium 6020.

In an embodiment, the non-transitory computer-readable medium 6020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 6020 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 6020 may store information that may be accessed by the control circuit 6015. For instance, the non-transitory computer-readable medium 6020 (e.g., memory devices) may store data 6025 that may be obtained, received, accessed, written, manipulated, created, and/or stored. The data 6025 may include, for instance, any of the data or information described herein. In some implementations, the computing system 6005 may obtain data from one or more memories that are remote from the computing system 6005.

The non-transitory computer-readable medium 6020 may also store computer-readable instructions 6030 that may be executed by the control circuit 6015. The instructions 6030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 6015 to perform one or more functional tasks. The modules and computer-readable/executable instructions may be described as performing various operations or tasks when the control circuit 6015 or other hardware component is executing the modules or computer-readable instructions.

The instructions 6030 may be executed in logically and/or virtually separate threads on the control circuit 6015. For example, the non-transitory computer-readable medium 6020 may store instructions 6030 that when executed by the control circuit 6015 cause the control circuit 6015 to perform any of the operations, methods and/or processes described herein. In some cases, the non-transitory computer-readable medium 6020 may store computer-executable instructions or computer-readable instructions, such as instructions to perform at least a portion of the method of FIG. 9.

In an embodiment, the computing system 6005 may store or include one or more machine-learned models 6035. For example, the machine-learned models 6035 may be or may otherwise include various machine-learned models, including any of the machine-learned models described herein. In an embodiment, the machine-learned models 6035 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models). As another example, the machine-learned models 6035 can include generative models, such as stable diffusion models, generative adversarial networks (GAN), GPT models, and other suitable models.

In an aspect of the present disclosure, the models 6035 may be used to collect and translate contextual information associated with commands received from a user (e.g., user 120) to personalize actions taken within the vehicle (e.g., vehicle 105). For example, the machine-learned models 6035 can, in response to sensor data 310 generate context data indicating one or more conditions associated with a prompt from the user 120. The models 6035 may utilize the context data to generate personalized output responses.

In an embodiment, the one or more machine-learned models 6035 may be received from the remote computing system 7005 over networks 9050, stored in the computing system 6005 (e.g., non-transitory computer-readable medium 6020), and then used or otherwise implemented by the control circuit 6015. In an embodiment, the computing system 6005 may implement multiple parallel instances of a single model.

Additionally, or alternatively, one or more machine-learned models 6035 may be included in or otherwise stored and implemented by the remote computing system 7005 that communicates with the computing system 6005 according to a client-server relationship. For example, the machine-learned models 6035 may be implemented by the remote computing system 7005 as a portion of a web service. Thus, one or more models 6035 may be stored and/or implemented (e.g., as models 7035) at the computing system 6005 and/or one or more models 6035 may be stored and implemented at the remote computing system 7005.

The computing system 6005 may include one or more communication interfaces 6040. The communication interfaces 6040 may be used to communicate with one or more other systems. The communication interfaces 6040 may include any circuits, components, software, etc. for communicating via one or more networks (e.g., networks 9050). In some implementations, the communication interfaces 6040 may include for example, one or more of a communications controller, receiver, transceiver, transmitter, port, conductors, software and/or hardware for communicating data/information.

The computing system 6005 may also include one or more user input components 6045 that receives user input. For example, the user input component 6045 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The computing system 6005 may include one or more output components 6050. The output components 6050 may include hardware and/or software for audibly or visually producing content. For instance, the output components 6050 may include one or more speakers, earpieces, headsets, handsets, etc. The output components 6050 may include a display device, which may include hardware for displaying a user interface and/or messages for a user. By way of example, the output component 6050 may include a display screen, CRT, LCD, plasma screen, touch screen, TV, projector, tablet, and/or other suitable display components.

The remote computing system 7005 may include one or more computing devices 7010. In an embodiment, the remote computing system 7005 may include or is otherwise implemented by one or more computing devices onboard an autonomous drone. In instances in which the remote computing system 7005 includes computing devices within cloud infrastructure, such computing devices may operate according to sequential computing architectures, parallel computing architectures, or some combination thereof.

The remote computing system 7005 may include a control circuit 7015 and a non-transitory computer-readable medium 7020, also referred to herein as memory 7020. In an embodiment, the control circuit 7015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 7015 may be programmed by one or more computer-readable or computer-executable instructions stored on the non-transitory computer-readable medium 7020.

In an embodiment, the non-transitory computer-readable medium 7020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 7020 may store information that may be accessed by the control circuit 7015. For instance, the non-transitory computer-readable medium 7020 (e.g., memory devices) may store data 7025 that may be obtained, received, accessed, written, manipulated, created, and/or stored. The data 7025 may include, for instance, any of the data or information described herein. In some implementations, the server system 7005 may obtain data from one or more memories that are remote from the server system 7005.

The non-transitory computer-readable medium 7020 may also store computer-readable instructions 7030 that may be executed by the control circuit 7015. The instructions 7030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 7015 to perform one or more functional tasks. The modules and computer-readable/executable instructions may be described as performing various operations or tasks when the control circuit 7015 or other hardware component is executing the modules or computer-readable instructions.

The instructions 7030 may be executed in logically and/or virtually separate threads on the control circuit 7015. For example, the non-transitory computer-readable medium 7020 may store instructions 7030 that when executed by the control circuit 7015 cause the control circuit 7015 to perform any of the operations, methods and/or processes described herein. In some cases, the non-transitory computer-readable medium 7020 may store computer-executable instructions or computer-readable instructions, such as instructions to perform at least a portion of the method of FIG. 9.

The remote computing system 7005 may include one or more communication interfaces 7040. The communication interfaces 7040 may be used to communicate with one or more other systems. The communication interfaces 7040 may include any circuits, components, software, etc. for communicating via one or more networks (e.g., networks 7050). In some implementations, the communication interfaces 7040 may include for example, one or more of a communications controller, receiver, transceiver, transmitter, port, conductors, software and/or hardware for communicating data/information.

The computing system 6005 and/or the remote computing system 7005 may train the models 6035, 7035 via interaction with the training computing system 8005 that is communicatively coupled over the networks 9050. The training computing system 8005 may be separate from the remote computing system 7005 or may be a portion of the remote computing system 7005.

The training computing system 8005 may include one or more computing devices 8010. In an embodiment, the training computing system 8005 may include or is otherwise implemented by one or more server computing devices. In instances in which the training computing system 8005 includes plural server computing devices, such server computing devices may operate according to sequential computing architectures, parallel computing architectures, or some combination thereof.

The training computing system 8005 may include a control circuit 8015 and a non-transitory computer-readable medium 8020, also referred to herein as memory 8020. In an embodiment, the control circuit 8015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 8015 may be programmed by one or more computer-readable or computer-executable instructions stored on the non-transitory computer-readable medium 8020.

In an embodiment, the non-transitory computer-readable medium 8020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 8020 may store information that may be accessed by the control circuit 8015. For instance, the non-transitory computer-readable medium 8020 (e.g., memory devices) may store data 8025 that may be obtained, received, accessed, written, manipulated, created, and/or stored. The data 8025 may include, for instance, any of the data or information described herein. In some implementations, the training computing system 8005 may obtain data from one or more memories that are remote from the training computing system 8005.

The non-transitory computer-readable medium 8020 may also store computer-readable instructions 8030 that may be executed by the control circuit 8015. The instructions 8030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 8015 to perform one or more functional tasks. The modules and computer-readable/executable instructions may be described as performing various operations or tasks when the control circuit 8015 or other hardware component is executing the modules or computer-readable instructions.

The instructions 8030 may be executed in logically or virtually separate threads on the control circuit 8015. For example, the non-transitory computer-readable medium 8020 may store instructions 8030 that when executed by the control circuit 8015 cause the control circuit 8015 to perform any of the operations, methods and/or processes described herein. In some cases, the non-transitory computer-readable medium 8020 may store computer-executable instructions or computer-readable instructions, such as instructions to perform at least a portion of the methods of FIG. 9.

The training computing system 8005 may include a model trainer 8035 that trains the machine-learned models 6035, 7035 stored at the computing system 6005 and/or the remote computing system 7005 using various training or learning techniques. For example, the models 6035, 7035 may be trained using a loss function that evaluates quality of generated samples over various characteristics, such as similarity to the training data.

The training computing system 8005 may modify parameters of the models 6035, 7035 based on the loss function (e.g., generative loss function) such that the models 6035, 7035 may be effectively trained for specific applications in a supervised manner using labeled data and/or in an unsupervised manner.

In an example, the model trainer 8035 may backpropagate the loss function through the user intent model 1002 to modify the parameters (e.g., weights) of the generative model (e.g., 620). The model trainer 8035 may continue to backpropagate the clustering loss function through the machine-learned model, with or without modification of the parameters (e.g., weights) of the model. For instance, the model trainer 8035 may perform a gradient descent technique in which parameters of the machine-learned model may be modified in a direction of a negative gradient of the clustering loss function. Thus, in an embodiment, the model trainer 8035 may modify parameters of the machine-learned model based on the loss function.

The model trainer 8035 may utilize training techniques, such as backwards propagation of errors. For example, a loss function may be backpropagated through a model to update one or more parameters of the models (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

In an embodiment, performing backwards propagation of errors may include performing truncated backpropagation through time. The model trainer 8035 may perform a number of generalization techniques (e.g., weight decays, dropouts, etc.) to improve the generalization capability of a model being trained. In particular, the model trainer 8035 may train the machine-learned models 6035, 7035 based on a set of training data 8040.

The training data 8040 may include unlabeled training data for training in an unsupervised fashion. Furthermore, in some implementations, the training data 8040 can include labeled training data for training in a supervised fashion. For example, the training data 8040 can be or can include the sensor data 310 FIG. 6.

In an embodiment, if the user has provided consent/authorization, training examples may be provided by the computing system 6005 (e.g., of the user's vehicle). Thus, in such implementations, a model 6035 provided to the computing system 6005 may be trained by the training computing system 8005 in a manner to personalize the model 6035.

The model trainer 8035 may include computer logic utilized to provide desired functionality. The model trainer 8035 may be implemented in hardware, firmware, and/or software controlling a general-purpose processor. For example, in an embodiment, the model trainer 8035 may include program files stored on a storage device, loaded into a memory and executed by one or more processors. In other implementations, the model trainer 8035 may include one or more sets of computer-executable instructions that are stored in a tangible computer-readable storage medium such as RAM, hard disk, or optical or magnetic media.

The training computing system 8005 may include one or more communication interfaces 8045. The communication interfaces 8045 may be used to communicate with one or more other systems. The communication interfaces 8045 may include any circuits, components, software, etc. for communicating via one or more networks (e.g., networks 9050). In some implementations, the communication interfaces 8045 may include for example, one or more of a communications controller, receiver, transceiver, transmitter, port, conductors, software and/or hardware for communicating data/information.

The computing system 6005, the remote computing system 7005, and/or the training computing system 8005 may also be in communication with a user device 9005 that is communicatively coupled over the networks 9050.

The user device 9005 may include various types of user devices. This may include head-worn wearable devices (e.g., AR glasses, watches, etc.), handheld devices, tablets, or other types of devices.

The user device 9005 may include one or more computing devices 9010. The user device 9005 may include a control circuit 9015 and a non-transitory computer-readable medium 9020, also referred to herein as memory 9020. In an embodiment, the control circuit 9015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 9015 may be programmed by one or more computer-readable or computer-executable instructions stored on the non-transitory computer-readable medium 9020.

In an embodiment, the non-transitory computer-readable medium 9020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 9020 may store information that may be accessed by the control circuit 9015. For instance, the non-transitory computer-readable medium 9020 (e.g., memory devices) may store data 9025 that may be obtained, received, accessed, written, manipulated, created, and/or stored. The data 9025 may include, for instance, any of the data or information described herein. In some implementations, the user device 9005 may obtain data from one or more memories that are remote from the user device 9005.

The non-transitory computer-readable medium 9020 may also store computer-readable instructions 9030 that may be executed by the control circuit 9015. The instructions 9030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 9015 to perform one or more functional tasks. The modules and computer-readable/executable instructions may be described as performing various operations or tasks when the control circuit 9015 or other hardware component is executing the modules or computer-readable instructions.

The instructions 9030 may be executed in logically or virtually separate threads on the control circuit 9015. For example, the non-transitory computer-readable medium 9020 may store instructions 9030 that when executed by the control circuit 9015 cause the control circuit 9015 to perform any of the operations, methods and/or processes described herein. In some cases, the non-transitory computer-readable medium 9020 may store computer-executable instructions or computer-readable instructions, such as instructions to perform at least a portion of the method of FIG. 9.

The user device 9005 may include one or more communication interfaces 9035. The communication interfaces 9035 may be used to communicate with one or more other systems. The communication interfaces 9035 may include any circuits, components, software, etc. for communicating via one or more networks (e.g., networks 7050). In some implementations, the communication interfaces 9035 may include for example, one or more of a communications controller, receiver, transceiver, transmitter, port, conductors, software and/or hardware for communicating data/information.

The user device 9005 may also include one or more user input components 9040 that receives user input. For example, the user input component 9040 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input. In an embodiment, the input components 9040 may include audio and virtual components such as a microphone (e.g., voice commands), accelerometers/gyroscopes (e.g., physical commands), etc.

The user device 9005 may include one or more output components 9045. The output components 9045 may include hardware and/or software for audibly or visually producing content. For instance, the output components 9045 may include one or more speakers, earpieces, headsets, handsets, etc. The output components 9045 may include a display device, which may include hardware for displaying a user interface and/or messages for a user. By way of example, the output component 9045 may include a display screen, CRT, LCD, plasma screen, touch screen, TV, projector, tablet, and/or other suitable display components.

The one or more networks 9050 may be any type of communications network, such as a local area network (e.g., intranet), wide area network (e.g., Internet), or some combination thereof and may include any number of wired or wireless links. In general, communication over a network 9050 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

### Additional Discussion of Various Embodiments

Embodiment 1 relates to a computing system of a vehicle. The computing system may include a control circuit. The control circuit may be configured to receive a user prompt from a user associated with a vehicle, the user prompt indicative of a statement or a question. The control circuit may be configured to access sensor data associated with a surrounding environment of the vehicle, the sensor data including at least of (i) an image of the user, (ii) weather data, (iii) a location of the vehicle, or (iv) a timestamp captured by one or more vehicle sensors. The control circuit may be configured to generate, using a context engine configured to determine context data associated with at least one of the user or the vehicle, a modified user prompt based on the user prompt and the sensor data, wherein the modified user prompt supplements the user prompt with the context data, the context data providing one or more conditions associated with the user prompt. The control circuit may be configured to generate, based on the modified user prompt, a user response, wherein the user response implements an action corresponding to the statement or the question.

Embodiment 2 includes the computing system of embodiment 1. In this embodiment, the context engine may be configured to analyze the user prompt from the user. The context engine may be configured to, based on the analysis of the user prompt, access user preference data associated with the user, the user preference data associated with the one or more conditions. The context engine maybe configured to generate, based on the user prompt and the user preference data, the context data, wherein the context data is indicative of one or more user preferences associated with the user prompt.

Embodiment 3 includes the computing system of embodiment 2. In this embodiment, context engine may be configured to concatenate the context data with one or more supplemental topics, the one or more supplemental topics including additional information associated with the user preference data. The context engine may be configured to input the user prompt and the one or more supplemental topics into a machine-learned model, wherein the machine-learned model is configured to generate the user response.

Embodiment 4 includes the computing system of any of the embodiments 1 to 3. In this embodiment, the context engine may be configured to determine, based on the user prompt, the sensor data, and the user preference data, sentiment data associated with the user. The context engine may be configured to generate based on the sentiment data, the modified user prompt.

Embodiment 5 includes the computing system of any of the embodiments 1 to 4. In this embodiment, the sentiment data includes at least one of (i) a mood, (ii) a feeling, or (iii) a tone of the user.

Embodiment 6 includes the computing system of any of the embodiments 1 to 5. In this embodiment, the control circuit is configured to generate voice analysis data for the user prompt, wherein the voice analysis data is indicative of a sentiment of the user.

Embodiment 7 includes the computing system of embodiment 6. In this embodiment, the one or more conditions associated with the user prompt includes the sentiment of the user.

Embodiment 8 includes the computing system of any of the embodiments 1 to 7. In this embodiment, the user prompt is received from a user computing device.

Embodiment 9 includes the computing system of any of the embodiments 1 to 8. In this embodiment, the user prompt is received from a vehicle interface located within the vehicle and physically coupled to the vehicle.

Embodiment 10 includes the computing system of any of the embodiments 1 to 9. In this embodiment, the action includes at least one of: (i) emitting an audio response; (ii) updating a user interface within the vehicle; (iii) adjusting a temperature setting within the vehicle; (iv) providing an entertainment suggestion; (v) providing a destination suggestion; or (vi) adjusting a comfort setting with the vehicle.

Embodiment 11 includes the computing system of any of the embodiments 1 to 10. In this embodiment, the control circuit may be configured to access the sensor data. The control circuit may be configured to, based on the sensor data, generate an automated user prompt, wherein the automated user prompt is associated with a predicted user prompt from the user.

Embodiment 12 includes the computing system of embodiment 11. In this embodiment, the control circuit is configured to implement the action in response to the automated user prompt.

Embodiment 13 includes the computing system of any of the embodiments 1 to 12. In this embodiment the one or more conditions associated with the user prompt comprises at least one of (i) a cabin temperature, (ii) a comfort setting, or (iii) a navigation preset.

Embodiment 14 relates to a computer-implemented method. The method can include receiving a user prompt from a user associated with a vehicle, the user prompt indicative of a statement or a question. The method can include accessing sensor data associated with a surrounding environment of the vehicle, the sensor data including at least of (i) an image of the user, (ii) weather data, (iii) a location of the vehicle, or (iv) a timestamp captured by one or more vehicle sensors. The method can include generating, using a context engine configured to determine context data associated with at least one of the user or the vehicle, a modified user prompt based on the user prompt and the sensor data, wherein the modified user prompt supplements the user prompt with the context data, the context data providing one or more conditions associated with the user prompt. The method can include generating, based on the modified user prompt, a user response, wherein the user response implements an action corresponding to the statement or the question.

Embodiment 15 includes the computer-implemented method of embodiment 14. In this embodiment, the method can include analyzing, using the context engine, the user prompt from the user. The method can include based on the analysis of the user prompt, accessing user preference data associated with the user, the user preference data associated with the one or more conditions. The method can include generating, using the context engine, based on the user prompt and the user preference data, the context data, wherein the context data is indicative of one or more user preferences associated with the user prompt.

Embodiment 16 includes the computer-implemented method of embodiment 15. In this embodiment, the method includes concatenating, using the context engine, the context data with one or more supplemental topics, the one or more supplemental topics including additional information associated with the user preference data. In this embodiment, the method can include inputting, by the context engine, the user prompt and the one or more supplemental topics into a machine-learned model, wherein the machine-learned model is configured to generate the user response.

Embodiment 17 includes the computer-implemented method of embodiments 15. In this embodiment, the method includes determining, using the context engine, based on the user prompt, the sensor data, and the user preference data, sentiment data associated with the user. IN this embodiment, the method includes generating, using the context engine, based on the sentiment data, the modified user prompt.

Embodiment 18 includes the computer-implemented method of embodiment 17. In this embodiment, the sentiment data includes at least one of (i) a mood, (ii) a feeling, or (iii) a tone of the user.

Embodiment 19 includes the computer-implemented method of any of the embodiments 14 to 18. In this embodiment, the method includes generating voice analysis data for the user prompt, wherein the voice analysis data is indicative of a sentiment of the user.

Embodiment 20 is directed to one or more non-transitory computer-readable media. The one or more non-transitory computer readable media can store instructions that are executable by a control circuit. The control circuit executing the instructions can receive a user prompt from a user associated with a vehicle, the user prompt indicative of a statement or a question. The control circuit executing the instructions can access sensor data associated with a surrounding environment of the vehicle, the sensor data including at least of (i) an image of the user, (ii) weather data, (iii) a location of the vehicle, or (iv) a timestamp captured by one or more vehicle sensors. The control circuit executing the instructions can generate, using a context engine configured to determine context data associated with at least one of the user or the vehicle, a modified user prompt based on the user prompt and the sensor data, wherein the modified user prompt supplements the user prompt with the context data, the context data providing one or more conditions associated with the user prompt. The control circuit executing the instructions can generate, based on the modified user prompt, a user response, wherein the user response implements an action corresponding to the statement or the question.

### Additional Disclosure

As used herein, adjectives and their possessive forms are intended to be used interchangeably unless apparent otherwise from the context and/or expressly indicated. For instance, “component of a/the vehicle” may be used interchangeably with “vehicle component” where appropriate. Similarly, words, phrases, and other disclosure herein is intended to cover obvious variants and synonyms even if such variants and synonyms are not explicitly listed.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, may readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment may be used with another embodiment to yield a still further embodiment. Thus, it is intended that the present disclosure cover such alterations, variations, and equivalents.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein may be adapted, rearranged, expanded, omitted, combined, or modified in various ways without deviating from the scope of the present disclosure. At times, elements may be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. may be performed before, after, or in parallel with another operation illustrated by a list identifier of (b), (ii), etc.

What is claimed is:

1. A vehicle computing system for controlling functionality of a vehicle comprising:
a control circuit configured to:
receive a user prompt from a user associated with a vehicle, the user prompt indicative of a statement or a question;
access sensor data associated with a surrounding environment of the vehicle, the sensor data comprising at least of (i) an image of the user, (ii) weather data, (iii) a location of the vehicle, or (iv) a timestamp captured by one or more vehicle sensors;
generate, using a context engine configured to determine context data associated with at least one of the user or the vehicle, a modified user prompt based on the user prompt and the sensor data, wherein the modified user prompt supplements the user prompt with the context data, the context data providing one or more conditions associated with the user prompt; and
generate, based on the modified user prompt, a user response, wherein the user response implements an action corresponding to the statement or the question.

2. The vehicle computing system of claim 1, wherein the context engine is configured to:
analyze the user prompt from the user;
based on the analysis of the user prompt, access user preference data associated with the user, the user preference data associated with the one or more conditions; and
generate, based on the user prompt and the user preference data, the context data, wherein the context data is indicative of one or more user preferences associated with the user prompt.

3. The vehicle computing system of claim 2, wherein the context engine is configured:
concatenate the context data with one or more supplemental topics, the one or more supplemental topics comprising additional information associated with the user preference data; and
input the user prompt and the one or more supplemental topics into a machine-learned model, wherein the machine-learned model is configured to generate the user response.

4. The vehicle computing system of claim 2, wherein the context engine is configured to:
determine, based on the user prompt, the sensor data, and the user preference data, sentiment data associated with the user; and
generate based on the sentiment data, the modified user prompt.

5. The vehicle computing system of claim 4, wherein the sentiment data comprises at least one of (i) a mood, (ii) a feeling, or (iii) a tone of the user.

6. The vehicle computing system of claim 1, wherein the control circuit is configured to:
generate voice analysis data for the user prompt, wherein the voice analysis data is indicative of a sentiment of the user.

7. The vehicle computing system of claim 6, wherein the one or more conditions associated with the user prompt comprise the sentiment of the user.

8. The vehicle computing system of claim 1, wherein the user prompt is received from a user computing device.

9. The vehicle computing system of claim 1, wherein the user prompt is received from a vehicle interface located within the vehicle and physically coupled to the vehicle.

10. The vehicle computing system of claim 1, wherein the action comprises at least one of:
(i) emitting an audio response;
(ii) updating a user interface within the vehicle;
(iii) adjusting a temperature setting within the vehicle;
(iv) providing an entertainment suggestion;
(v) providing a destination suggestion; or
(vi) adjusting a comfort setting with the vehicle.

11. The vehicle computing system of claim 1, wherein the control circuit is configured to:
access the sensor data; and
based on the sensor data, generate an automated user prompt, wherein the automated user prompt is associated with a predicted user prompt from the user.

12. The vehicle computing system of claim 11, wherein the control circuit is configured to:
implement the action in response to the automated user prompt.

13. The vehicle computing system of claim 1, wherein the one or more conditions associated with the user prompt comprises at least one of (i) a cabin temperature, (ii) a comfort setting, or (iii) a navigation preset.

14. A computer-implemented method for controlling functionality of a vehicle comprising:
receiving a user prompt from a user associated with a vehicle, the user prompt indicative of a statement or a question;
accessing sensor data associated with a surrounding environment of the vehicle, the sensor data comprising at least of (i) an image of the user, (ii) weather data, (iii) a location of the vehicle, or (iv) a timestamp captured by one or more vehicle sensors;
generating, using a context engine configured to determine context data associated with at least one of the user or the vehicle, a modified user prompt based on the user prompt and the sensor data, wherein the modified user prompt supplements the user prompt with the context data, the context data providing one or more conditions associated with the user prompt; and
generating, based on the modified user prompt, a user response, wherein the user response implements an action corresponding to the statement or the question.

15. The computer-implemented method of claim 14, further comprising:
analyzing, using the context engine, the user prompt from the user;
based on the analysis of the user prompt, accessing user preference data associated with the user, the user preference data associated with the one or more conditions; and
generating, using the context engine, based on the user prompt and the user preference data, the context data, wherein the context data is indicative of one or more user preferences associated with the user prompt.

16. The computer-implemented method of claim 15, further comprising:
concatenating, using the context engine, the context data with one or more supplemental topics, the one or more supplemental topics comprising additional information associated with the user preference data; and
inputting, by the context engine, the user prompt and the one or more supplemental topics into a machine-learned model, wherein the machine-learned model is configured to generate the user response.

17. The computer-implemented method of claim 15, further comprising:
determining, using the context engine, based on the user prompt, the sensor data, and the user preference data, sentiment data associated with the user; and
generating, using the context engine, based on the sentiment data, the modified user prompt.

18. The computer-implemented method of claim 17, wherein the sentiment data comprises at least one of (i) a mood, (ii) a feeling, or (iii) a tone of the user.

19. The computer-implemented method of claim 14, further comprising:
generating voice analysis data for the user prompt, wherein the voice analysis data is indicative of a sentiment of the user.

20. One or more non-transitory computer-readable media storing instructions executable by a control circuit to:
receive a user prompt from a user associated with a vehicle, the user prompt indicative of a statement or a question;
access sensor data associated with a surrounding environment of the vehicle, the sensor data comprising at least of (i) an image of the user, (ii) weather data, (iii) a location of the vehicle, or (iv) a timestamp captured by one or more vehicle sensors;
generate, using a context engine configured to determine context data associated with at least one of the user or the vehicle, a modified user prompt based on the user prompt and the sensor data, wherein the modified user prompt supplements the user prompt with the context data, the context data providing one or more conditions associated with the user prompt; and
generate, based on the modified user prompt, a user response, wherein the user response implements an action corresponding to the statement or the question.
